(19) United States
(12) Patent Application Publication
(10) Pub. No.: US 2003/0105812 A1
(43) Pub. Date: Jun. 5, 2003

(54) Hybrid system architecture for secure peer-to-peer-communications

(75) Inventors: John M. Flowers JR., Broad Run, VA (US); Cynthia L. Flowers, Broad Run, VA (US); Thu Rein Kyaw, Reston, VA (US)

Correspondence Address: McDERMOTT, WILL & EMERY, 600 13th Street, N.W., Washington, DC, 20005-3096, US

(73) Assignee: GIGAMEDIA ACCESS CORPORATION

(21) Appl. No.: 10/212,742

(22) Filed: Aug. 7, 2002

Related U.S. Application Data
(60) Provisional application No. 60/310,825, filed on Aug. 9, 2001.
(60) Provisional application No. 60/310,826, filed on Aug. 9, 2001.
(60) Provisional application No. 60/310,830, filed on Aug. 9, 2001.
(60) Provisional application No. 60/315,986, filed on Aug. 31, 2001.
(60) Provisional application No. 60/316,008, filed on Aug. 31, 2001.
(60) Provisional application No. 60/316,039, filed on Aug. 31, 2001.
(60) Provisional application No. 60/338,640, filed on Dec. 11, 2001.
(60) Provisional application No. 60/353,204, filed on Feb. 4, 2002.

(51) Int. Cl. G06F 15/16

(52) U.S. Cl. 709/203

(57) ABSTRACT

The disclosed hybrid architecture provides secure peer-to-peer communication between devices such as computers, wireless devices, personal digital assistants (PDAs), web enabled phones or the like. This architecture includes a server or Peer Switch, which acts as an intermediary to facilitate the session and provide authentication to ensure system security. In some cases it may also provide the capability necessary to traverse firewalls and deal with proxies and other obstacles to peer-to-peer communications. The hybrid architecture allows centralized administration and policy management of authentication, obstacle transversal and security methods, to ensure the overall system integrity required by business systems. Typical peer user devices implement peer client programming, for signaling communication with the server and for peer-to-peer communications with other peer devices. A web server may also provide access via standard browsers, for users having devices lacking the peer client software.

### CROSS-REFERENCE TO RELATED APPLICATIONS

This application claims the benefit of U.S. Provisional Application No. 60/310,825 entitled “PeerBook Architecture” filed on Aug. 9, 2001, the disclosure of which is entirely incorporated herein by reference.

This application claims the benefit of U.S. Provisional Application No. 60/310,826 entitled “Peer-to-Peer Shared Access to Microsoft Outlook Information” filed on Aug. 9, 2001, the disclosure of which is entirely incorporated herein by reference.

This application also claims the benefit of U.S. Provisional Application No. 60/310,830 entitled “PeerMail Architecture” filed on Aug. 9, 2001, the disclosure of which is entirely incorporated herein by reference.

This application also claims the benefit of U.S. Provisional Application No. 60/315,986 entitled “Protocol for Communicating Between a PeerBook Client Process and a PeerSwitch Server Process” filed on Aug. 31, 2001, the disclosure of which is entirely incorporated herein by reference.

This application also claims the benefit of U.S. Provisional Application No. 60/316,008 entitled “Protocol for Communicating Between a PeerBook Client Processes” filed on Aug. 31, 2001, the disclosure of which is entirely incorporated herein by reference.

This application also claims the benefit of U.S. Provisional Application No. 60/316,039 entitled “Process by which One Computer Facilitates or Brokers the Creation of a TCP/IP Connection Between Two Other Computers” filed on Aug. 31, 2001, the disclosure of which is entirely incorporated herein by reference.

This application also claims the benefit of U.S. Provisional Application No. 60/338,640 entitled “Process for Establishing a Virtual TCP/IP Connection” filed on Dec. 11, 2001 the disclosure of which is entirely incorporated herein by reference.

This application also claims the benefit of U.S. Provisional Application No. 60/353,204 entitled “Process for Establishing a Virtual TCP/IP Connection Using a PeerProxy” filed on Feb. 4, 2002, the disclosure of which is entirely incorporated herein by reference.

### FIELD OF INVENTION

The present subject matter relates to techniques, software and equipment for enhancing a variety of peer-to-peer communications services, as may be conducted via diverse end-user devices.

### BACKGROUND

The development and recent widespread acceptance of the public Internet has revolutionized the way people communicate. Technically, the Internet is a large constellation of interconnected networks, which enable digital communications between linked computers that may be located virtually anywhere on the planet. One common use of the Internet relates to accessing publicly available or “posted” information on Internet web sites. An individual creates and publishes a Web page and any linked multimedia content by storing the information on a web server and publishing the URL (Universal Resource Locator) needed to link to and access the material on the web server. From a user's perspective, once the web site is posted and available, the Internet serves as a presentation tool that allows users to find, access and review the information on the page and the linked content.

Another common use of the Internet relates to electronic mail or “e-mail.” For this type of communication, a user composes an electronic message using commonly available electronic mail software. By specifying one or more Internet e-mail addresses of the intended recipient(s), the user simply activates the programmed terminal to transmit the message through the network. The message is then routed through the Internet, via one or more e-mail servers, until notice of the message arrives at the destination computing device. The intended recipient activates her terminal to retrieve and review the message and any attached documents.

The common forms of Internet usage, such as the web access and e-mail communication, have become virtually ubiquitous tools of modern business life, and they are becoming increasingly common in modern households in many countries. In one form or another, these common forms of communication typically rely on a “client-server” approach. The end user operates a computer or other terminal that runs a client application, such as an e-mail program or web browser, that enables the user's device to communicate through the Internet with another computer running a corresponding server application. At the minimum, with such an approach, to exchange information from one end user to another requires that the first user upload information to the server and the second end user to obtain the information from the server.

The Internet also provides a means for establishing a communication link between two remote computers for “peer-to-peer” or one-to-one communication between devices. Such peer-to-peer sessions allows two computer users to conduct a conversation (e.g. instant messaging, voice telephony over the Internet or video conferencing), exchange files, or participate in real-time gaming, without ongoing uploading and downloading via a server. For live interactivity, establishing a peer-to-peer communication session through the Internet, however, may be difficult, and a number of common security systems and the like can further complicate or completely inhibit such peer-to-peer communications.

In the past, a user desiring a peer-to-peer session needed to schedule in advance a time when both users would connect to the Internet. At the appointed time, the first user would connect to the Internet to publish her dynamically assigned Internet Protocol (IP) address using an address location service. The second user would then connect and use the same address location service to lookup the network address of the first user. Alternatively, after connecting to the Internet the first user may manually lookup their temporary network address and communicate it to the second user. Assuming both users are simultaneously connected, the two remote users could then establish a peer-to-peer connection. Comparable to trying to meet someone at an airport, this process is complicated, frustrating and unpredictable.

The peer-to-peer model also has been used to provide distributed content-sharing or file-sharing, for exchanging data among large numbers of users. In peer-to-peer sharing networks, each computer or node can operate as a hub, having both client and server functionality. To implement such sharing each node has a list of addresses, typically IP addresses, of other nodes or peers in the group. These nodes can directly communicate with each other without a central or intermediate server. As shown by this discussion, however, all of the nodes that participate must know of the addresses of the other nodes.

Modern society also is becoming increasingly mobile. Particularly among the “professional” ranks. Mobile workers require access to the same data resources they have in their home office as well as communications with their clients and coworkers. Hence, for mobile professionals and increasingly for private individuals, there is an increasing need for a more flexible and sophisticated data access. Many new communications services have emerged, to allow people to communicate freely as they roam, without the need for a fixed network connection. These newer services adequately address issues relating to many typical client server type communications, however, mobility further complicates problems relating to peer-to-peer sessions. For example, the added dynamics of the addressing to and from mobile terminals further complicates establishment of the peer-to-peer relationship.

Modern mobility also gives rise to situations where a professional or other person needs to remotely access and/or control the person's PC or other computer in their office or place of residence. Certain of the systems for such remote access often require a remote computer to communicate with the host computer or home-network via a telephone line and modem. To enable such remote access, both the host computer and the remote computer must have matching remote control application software, such as PC Anywhere® or Laplink®. Alternatively, establishment of a remote access session through the Internet requires a peer-to-peer session via the Internet. If the user prefers the Internet peer-to-peer approach (instead of a direct dial-up modem link), the remote access attempt runs into all the above discussed problems with establishing a peer-to-peer connection.

As noted above, a number of common security systems and the like can further complicate or completely inhibit peer-to-peer communications. For example, some firewalls and/or proxy servers block certain types of message exchanges commonly used to establish peer-to-peer sessions, for example, because one of the necessary addresses is blocked or unknown to the firewall. Hence, if one of the peers is behind the firewall or proxy server, the normal session set-up techniques are ineffective.

Clearly, there is a need for better techniques for peer-to-peer communications between disparate types of terminals, many of which may at least at times be mobile. In any effort to address such a general need, there are a number of goals to strive toward. One such goal is to facilitate effective and easy collaboration between people working on computers or other user devices through the sharing of files, email, and other information. The architecture and methodology should facilitate easy session establishment, yet provide security. The peer-to-peer communications also should allow a person to access the files, emails, and other information on his or her normal computing device, or control that device from a remote location from a number of different kinds of devices, such as PDAs, web enabled mobile telephones, and remote PCs. The peer-to-peer communications should achieve these goals in communications across a variety of network obstacles (e.g. firewalls, proxy servers, NAT, and slow wireless connections) that otherwise make the peer-to-peer communications difficult, if not impossible, to accomplish with existing technology. Another goal is to allow the peer-to-peer communications to be extensible through the use of software development kits (SDKs) or application programming interfaces (APIs) to support access to third-party applications.

### SUMMARY

The inventive concepts meet one or more of the above noted needs and address one or more of the problems with services relating to peer-to-peer communications. Concepts disclosed herein relate to methods, software and systems for enabling session set-up and conducting peer-to-peer communications. The concepts support a variety of peer-to-peer communications, such as information sharing, remote control, conferencing, instant messaging, and the like. Also, the embodiments of the peer-to-peer communications techniques facilitate such service applications among a wide range of common peer user devices, which in turn may access the data network in a variety of different ways. The disclosed embodiments provide useful tools for managing peer-to-peer communications and shared information as well as techniques for establishing peer-to-peer communication sessions across common obstacles, such as firewalls and/or proxy servers.

A disclosed system embodiment provides peer-to-peer communication services via a data network, such as the Internet. The system comprises peer devices and a peer server. A peer device has a user interface and a network interface, for enabling communications over the data network. The peer server is coupled for data communication via the data network. The peer server provides session establishment services for the peer devices. Typically, a peer device has a programmable controller and program storage, which contains a peer client program. The peer client program enables the peer device to conduct signaling communications with the peer server and to conduct a peer-to-peer communication in a session with an other one of the peer devices.

In disclosed embodiments, the system also includes a web server for providing a web page interface for a browser implemented by one of the peer devices, which lacks the peer client program. The web server also provides a proxy peer client program for use by that peer device. The proxy peer client program and the web page interface enable signaling communications with the server as well as a peer-to-peer communication via the web server with an other one of the peer devices via the data network, for example, analogous to communications by a device having its own internally stored peer client program.

As noted, the peer-to-peer communications include a wide array of different types of communications that users may desire to exchange between their peer devices. Examples of such communications include: file sharing, folder sharing, e-mail message transfer, instant messaging, remote control, voice conversation, and video conferencing. The system enables users to access the various peer services from different types of computing devices. Disclosed examples include: personal computers (desktops and/or laptops), personal digital assistants and wireless mobile telephone devices.

In the disclosed embodiments, the peer server maintains a database of users and information as to which peer devices are on-line at a given time. The signaling communications include signaling to the peer devices of on-line status of other peer devices. Implementations of the service involve identifying users (and their peer devices) as members of respective communities, and defining sub-groups of community members as separate teams, for example, for sharing of files and folders.

Disclosed embodiments of the peer client program comprise a peer service manager routine and a peer service user interface program. The peer service manager routine manages accessing of local information on the user device, for example, for sharing via the peer-to-peer communications. The manager also handles network connections, for the signaling communications and for the peer-to-peer communications. The peer service user interface program acts as a front-end for the peer service manager routine. In PC embodiments of the peer client program, the peer service user interface program implements an application program interface, for interaction with another program in the user device having a user interface functionality. Typically, the other application program is a personal information manager (PIM), such as Microsoft Outlook.

Embodiments of the web server comprise a user interface program supporting browser interaction via the data network, typically in the form of a web page server program. The web server also runs a web implementation of the peer client program, including a peer service manager routine. The disclosed browser access via the web server supports common types of personal computer browsers, personal digital assistant browsers and wireless application protocol browsers.

Hence, a disclosed hybrid architecture for a Peer Switch System provides secure peer-to-peer communication between diverse end user devices, such as computers (desktop, handheld and laptop), wireless devices like Personal Digital Assistants (PDAs) or web enabled phones, or other devices. Generally, “Peer-to-Peer” systems are pure systems where one device communicates directly with another device or peer. The inventive design includes a server or Peer Switch, which acts as an intermediary to facilitate the connection and provide authentication to ensure system security. In some cases it may also provide the capability necessary to traverse firewalls and deal with proxies, Network Address Translation (NAT) and other obstacles to communications. This architecture allows centralized administration and policy management of authentication, firewall transversal and other security methods to ensure the overall system integrity required by business systems.

The inventive peer-to-peer service concepts encompass methods and systems for implementing the disclosed service features, for example, including specific server implementations and specific user device implementations. Other examples include method embodiments for brokering connections between peers wherein one or both of the peers reside behind a firewall or behind a proxy server.

For example, one disclosed method enables establishment of a desired connection for a peer-to-peer communication session through a network, between an originating peer device and an intended destination peer device, where at least the intended destination peer device is behind a firewall. The originating peer device communicates a request for a desired connection with the intended destination peer device, to a broker device. This first request provides the broker device with session related data assigned by the originating peer device, such as the port number that device intends to use for the session. The broker sends a request to establish the connection, to the intended destination peer device. This second request forwards the session related data assigned by the originating peer device, to the intended destination peer device. In response, the intended destination peer device sends an acceptance to the broker device. The acceptance includes session related data assigned by the intended destination peer device, such as the port number that will be used by that device. The broker sends an acknowledgment, to the originating peer device. This acknowledgment contains provides the session related data assigned by the intended destination peer device.

The two peer devices both attempt to initiate a direct peer-to-peer session. However, any firewalls that may be in front of such devices will typically block session set-up messages that do not originate from devices behind the firewalls. In the disclosed methodology, the originating peer device sends an initial session packet of the desired connection with the intended destination peer device through the data network. Normally, the packet would go toward the destination device, but the associated firewall would block the packet. In the embodiment, however, this transmission is adapted so that the packet is received by the broker device. In a similar manner, the intended destination peer device also sends an initial session packet through the data network, in such a manner that it is received by the broker device. The broker device formulates and forwards acknowledgements of the initial session packets to the respective devices, after which, the originating peer device and the intended destination peer device conduct peer-to-peer communications through the network, via the established session link.

Another inventive method establishes a desired connection for a peer-to-peer communication session through a network between an originating peer device and an intended destination peer device, where the devices reside behind proxy servers. In the disclosed embodiment, the originating peer device sends a request for a connection to a broker server. The broker server generates two random values and supplies those numbers to a peer proxy. In the disclosed embodiment, the peer proxy may be a function of the peer server or of anther server on the network. Those skilled in the art will recognize that the peer proxy functionality may reside in any device or node accessible via the network. The broker provides one of the random values to each of the originating peer devices.

Typically, peer proxy servers will not allow establishment of session connections in response to incoming requests. The proxy servers enable establishment of only outgoing connections. The originating peer device initiates a first connection, across a first proxy server, to the peer proxy. To the first proxy server, this would look like a normal outgoing connection. As part of the related signaling, the originating peer device sends the first random number to the peer proxy. The intended destination peer device similarly initiates a second connection to the peer proxy and sends the second random value to the peer proxy. To the second proxy server, this also would look like a normal outgoing connection. In response to receipt of the random values from the two peer devices, the peer proxy enables communications between the first and second connections, for example, by logically coupling the two connections together.

Additional inventive concepts relate to software or program products, for example, implementing the peer client functionality. A software or program product includes information, which may be carried by at least one machine-readable medium. The information carried by the medium may be executable code, one or more databases and/or information regarding shared files or the like. In disclosed embodiments of program products intended for user devices, the information comprises executable code for causing one or more programmable devices to implement the peer manager and the peer user interface.

A computer or machine readable medium, as used herein, may be any physical element or carrier wave, which can bear instructions or code for performing a sequence of steps in a machine-readable form or associated data. Examples of physical forms of such media include floppy disks, flexible disks, hard disks, magnetic tape, any other magnetic medium, a CD-ROM, any other optical medium, a RAM, a ROM, a PROM, an EPROM, a FLASH-EPROM, any other memory chip or cartridge, as well as media bearing the software in a scannable format. A carrier wave type of medium is any type of signal that may carry digital information representative of the data or the instructions or code for performing a sequence of steps. Such a carrier wave may be received via a wireline or fiber-optic network, via a modem, or as a radio-frequency or infrared signal, or any other type of signal which a computer or the like may receive and decode.

Additional objects, advantages and novel features of the embodiments will be set forth in part in the description which follows, and in part will become apparent to those skilled in the art upon examination of the following and the accompanying drawings or may be learned by production or operation of the embodiments. The objects and advantages of the inventive concepts may be realized and attained by means of the methodologies, instrumentalities and combinations particularly pointed out in the appended claims.

### BRIEF DESCRIPTION OF THE DRAWINGS

The drawing figures depict preferred embodiments by way of example, not by way of limitations. In the figures, like reference numerals refer to the same or similar elements.

FIG. 1 is a simplified block diagram of devices enabling and conducting peer-to-peer communications in accord with an embodiment referred to herein as a Peer Switch embodiment.

FIG. 2 is a functional block diagram of networks and hardware systems that may be involved in implementation of the peer-to-peer communications of FIG. 1.

FIG. 3 is a simplified block diagram of a general purpose computer, for example, usable as one of the users' personal computers in FIG. 2.

FIG. 4 is a simplified block diagram of a general purpose computer, for example, usable as one of the servers in FIG. 2.

FIG. 5 is a simplified block diagram of a wireless mobile telephone device, usable in the system of FIG. 2.

FIG. 6 is a simplified block diagram of a portable hand-held computing device, such as a personal digital assistant (PDA) with wireless communications capabilities, usable in the system of FIG. 2.

FIG. 7 is a simplified block diagram of Peer Switch client software, as may be used in the embodiment of FIG. 1

FIG. 8 illustrates an exemplary user interface screen, useful in an embodiment such as that of FIG. 1.

FIG. 9 is a simplified block diagram of exemplary Peer Switch web server software, as may be used in the embodiment of FIG. 1

FIGS. 10A and 10B illustrate two browser display screens, as might appear on a PDA, when accessing the Peer Switch web server in the embodiment of FIG. 1.

FIG. 11 is a block and signaling link diagram useful in explaining certain procedures for conducting peer-to-peer sessions between Peer Switch clients in the embodiment of FIG. 1, e.g. where one or more of the peers are behind a firewall.

FIG. 12 is a block and signaling link diagram useful in explaining a process of establishing a peer-to-peer session via a peer proxy, to insure session establishment where the two peers are behind proxy servers.

FIG. 13 is a simplified functional block diagram illustrating the elements involved and the communications conducted, in a PeerMail embodiment.

FIG. 14 is a simplified functional block diagram illustrating the software architecture utilized in the PeerMail embodiment of FIG. 13.

### DETAILED DESCRIPTION

The various embodiments disclosed herein relate to systems, techniques and/or software products for implementing different peer-to-peer communications and associated services. In the embodiments, a server provides addressing and signaling services to assist in establishing peer-to-peer sessions. The server authenticates all users and may perform other security related functions, such as providing digital certificates to peer devices so as to facilitate mutual authentication. A user may log-in from two or more computers that are on-line at the same time, for example, to allow a mobile user to control his home or office PC from a mobile computing device. Most user devices will run a peer service client application. The application may be specifically adapted as a standalone program to run on the particular device, e.g. on a particular brand of PDA. In most cases, the peer service application runs within an otherwise standard/existing personal information manager (PIM) program resident on the user's PC or the like. However, for access from devices without such a peer service client, the same or a second server provides a web interface. The web server provides standard web browser interactivity to the user but runs a peer service client application to allow access to the peer-to-peer communication services. To a peer device, the combination of the device with the browser and the web server appears to be a peer device.

In the embodiments, the peer-to-peer services provide communications to other persons (or their devices) within established groups, referred to as communities. Smaller groups (teams), within a community, share information. The embodiments support a variety of peer-to-peer communications between users, including file sharing, instant messaging, remote control and the like.

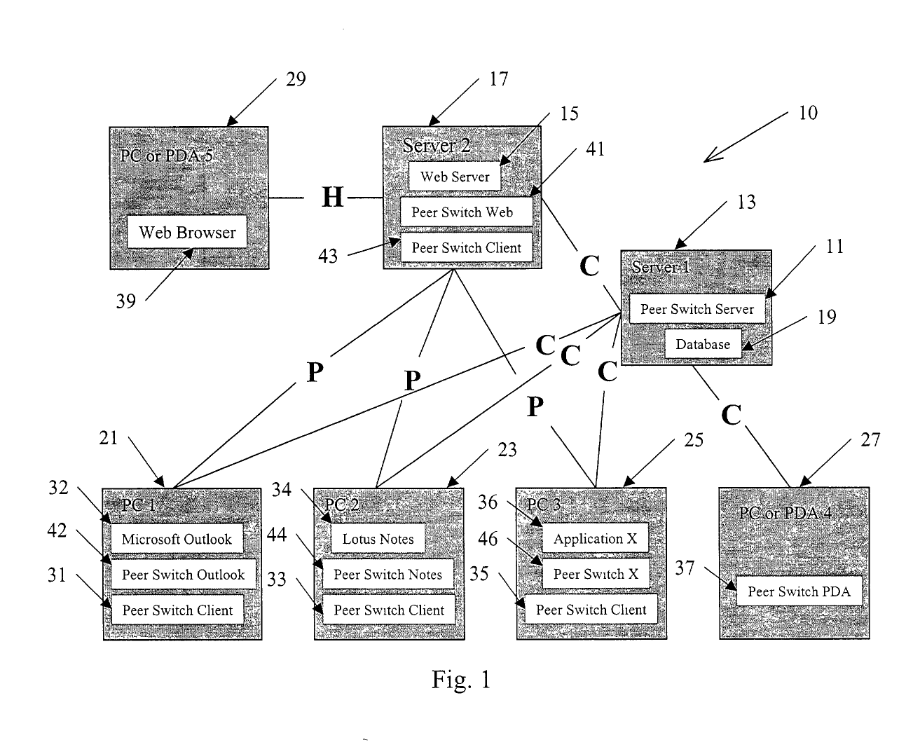

Reference now is made in detail to the presently preferred embodiments, examples of which are illustrated in the accompanying drawings and discussed below. As noted, the peer-to-peer service involves communications between a variety of end user devices, where the users are members of communities and teams; and appropriate application servers facilitate the peer-to-peer services. For discussion purposes, FIG. 1 illustrates an implementation of a hybrid “Peer Switch” architecture that enables peer-to-peer communications between diverse data communications devices across network boundaries, and in some case, across boundaries such as firewalls. The architecture is “hybrid” in that it utilizes client-server communications for some functions (e.g., signaling for session set-up and for web access) and uses peer-to-peer communications for most communications between end users and/or between peer devices.

The illustrated Peer Switch embodiment 10 consists of three principal components, the Peer Switch functionality 11 implemented in server 1 (13), the Peer Switch client implemented in various client devices, and the Peer Switch web server 15. As shown, the system utilizes two servers, server 1 (13) performs the Peer Switch functions 11, whereas server 2 (17) performs the peer web server functions 15. Those skilled in the art will recognize that one physical server computer might perform both of these functions (11 and 15), or the functions/servers could be replicated at various nodes throughout the data network.

The Peer Switch functionality (11) is responsible for authenticating users into a Peer Switch community, and for several administrative activities including presence mapping. For these operations, the server 13 typically maintains an associated database 19.

The Peer Switch client, or peer, resides on the user's PC, PDA or other data device. The example in FIG. 1 includes five peers. The first three peers 21, 23 and 25 are PCs. PCs 21, 23 and 25 run Peer Switch client applications 31, 33 and 35, as well as other applications. As shown in this example, the client device 27 may be a PC or a PDA, and in this example, the device 27 runs the a Peer Switch client 37 adapted for PDA operation. In each case, the Peer Switch client 31, 33, 35 or 37 carries out the majority of functions between itself and other peers or between itself and the server 11.

The fifth exemplary client device 29 also may be a PC or a PDA, but for purposes of this discussion, it is assumed that the device 29 runs only a web browser application. The Peer Switch Web functionality 15 provides access to the Peer Switch community, remotely through a web server, for example via the browser application 39 in the client device 29. To that end, the web server 15 implements a web interface 41 to the browser as well as a Peer Switch client 43, such that the server 17 effectively becomes a client-proxy for the device 29 that lacks its own client application.

The Peer Switch embodiment 10 utilizes a number of different types of logical communication connections, as depicted in FIG. 1. For convenience of discussion, the different connections are marked with a letter code. The C connections extend between peers and the Peer Switch 11. Information communicated through such a connection includes user authentication, presence mapping, and peer-to-peer connection requests. The P connections are true peer-to-peer links that extend between peer devices. Information communicated through such a connection includes email and file transfers, instant message sessions, and folder listings. H type connections extend between Web browsers on PCs or PDAs and the Peer Switch Web.

The drawings show peer connections P, for the device 29, extending between the web server 17 and several other peer devices 21, 23 and 25. For convenience, peer connections that may be established between devices such as 21, 23, 25 and 27 are omitted.

The Peer Switch functionality 11 dynamically maintains a database 19 of users, teams, and shares within a community. The “shares” for purposes of this discussion are files and folders that the peers make available for sharing with the other members of their team(s), as established through the Peer Switch service. The Peer Switch 11 also authenticates users into the community and into respective teams established by community members. The peer users modify the information available for sharing, and the members of the various communities and teams change over time; and as a result, the Peer Switch functionality 11 must keep its records in database 19 current.

As needed, the Peer Switch functionality 11 generates digital certificates on the fly, for example, when two clients want to connect with each other so they can authenticate one another. The server 13 also notifies users when shares and other users become available or unavailable. Several of these functions may involve a presence mapping of the users and their peer devices, by the Peer Switch server 11. The server 13 also stores and delivers notes sent between users within the community. Another function of the Peer Switch functionality 11 is to facilitate connections between peers, for example, when firewalls, proxies and NAT systems exist in the network between the peers.

Members of the same community can directly communicate with each other via peer-to-peer sessions established using the Peer Switch services, for example, for instant messaging. Within a community, users can be sub-grouped into teams for sharing information stored on peer devices. Normally, a community consists of employees (and/or their remote controlled computers) from one company. However, a community or team is not limited to that scenario. In a business context, for example, business partners or key subcontractors or the like may be added to the working community or team.

Any computing device, which has the Peer Switch client software or is set-up for peer access using a browser and the web server, becomes a “peer” device of the community that was defined during the community's registration process. The database maintains record(s) identifying the users/users' devices and the association(s) thereof with the various established communities and teams. A computing device may be a member of more than one community. Any files or folders that are accessible from a peer member of a community are eligible for sharing with community teams. Team members access the shared information (“shares”) via a peer device using the Peer Switch client software or via a remote device 29 having a browser 39 and using the Peer Switch web server 17.

The intent is for the generic Peer Switch client application to provide the same functionality, regardless of the particular device or software environment in which the application runs. For example, FIG. 1 shows the three PCs 21, 23 and 25 running different applications for work sharing, typically various types of PIMs. In the example the first personal computer (PC 1) 21 runs Microsoft Outlook application 32, the second personal computer (PC 2) 23 runs Lotus Notes application 34, whereas the third personal computer (PC 3) 25 runs some other PIM program referred to as “Application X” 36. However, the Peer Switch clients 31, 33 and 35 are all the same application (as substantially is the client 43).

To provide appropriate inter-working between the generic Peer Switch client programs 31, 33 and 35 and the different user's PIM programs 32, 34 and 36 running on the PCs 21, 23 and 25, each PC runs an interface program corresponding to the particular user communication program 32, 34 or 36. Typically, each such interface program or routine implements an application programming interface (API), which provides a logical interface between the particular personal information managers (PIM) or other user software and the generic Peer Switch client program.

For example, in the first personal computer (PC 1) 21, the Peer Switch “Outlook” interface program 42 provides the necessary two-way program calls and responses to allow Microsoft Outlook 32 to interact with and communicate through the generic Peer Switch client application shown at 31. Similarly, in the second personal computer (PC 2) 23 the Peer Switch “Lotus Notes” interface program 44 provides the necessary two-way program calls and responses to allow Lotus Notes 34 to interact with and communicate through the generic Peer Switch client application shown at 33. The Peer Switch interface for program X 46 provides the necessary two-way program calls and responses to allow the particular Application X 36 to interact with and communicate through the generic Peer Switch client application shown at 35, in the third personal computer (PC 3) 25.

As shown and discussed, the embodiment (FIG. 1) uses a common personal information manager or PIM, e.g. Microsoft Outlook, as a user interface (UI) application. For example, users already familiar with Outlook do not need to learn a new UI to use the peer system 10. However, the system is designed to allow it to be incorporated into other personal information managers (PIMs) and applications thereby making it easier to learn and use. For example, the illustrated system architecture of the Peer Switch embodiment 10 is designed to allow other interfaces such as Lotus Notes or other user interfaces.

As shown, the server 17 also runs a version of the generic Peer Switch client 43. The program 41, however, provides the appropriate interface to the web server functionality 15 and the ability to provide multiple instances of the program 41 for use by a number of users accessing the Peer Switch communities via the web server 15 and their standard PC web browsers 39. The version 43 of the Peer Switch client differs from the other client programs in that it may be operated substantially simultaneous for a relatively large number of users, having browser ready devices 29 that may not include their own client programming.

Several other useful features of the disclosed Peer Switch embodiment (FIG. 1) should also be noted at this time, although more details are provided later. For example, security is implemented on every network connection made by the system. Digital certificates are used for authentication, strong encryption is used to secure peer-to-peer sessions, and SSL is used to secure Web sessions. The Peer Switch embodiment also incorporates technology that allows it to establish connections between peers that are separated by network security devices such as firewalls and NAT. By establishing network connections directly between clients (i.e. peer-to-peer connections P), the Peer Switch embodiment 10 creates little or no overhead for servers. Information is shared directly from PC to PC or PC to other remote device.

As noted, users are grouped within communities. A community is a group of users that can potentially establish connections and share information with each other. A user can be a member of more than one community; however, two users must be members of the same community in order for them to establish a connection with each other. Within communities, users establish teams. A team is a group of users from the same community who share information. A user shares information with other users by sharing that information with a team. Information shared with a team is accessible to all members of that team. Users can be logged onto a community multiple times from different PCs or devices at the same time. Shares offered by a user are distinguished by machine name as well as by user. A user can access his own information remotely by sharing that information with a team that contains only him (and thus all devices he may use). When accessing the system remotely, he accesses not only his privately shared information, but also any and all information shared with him within the community.

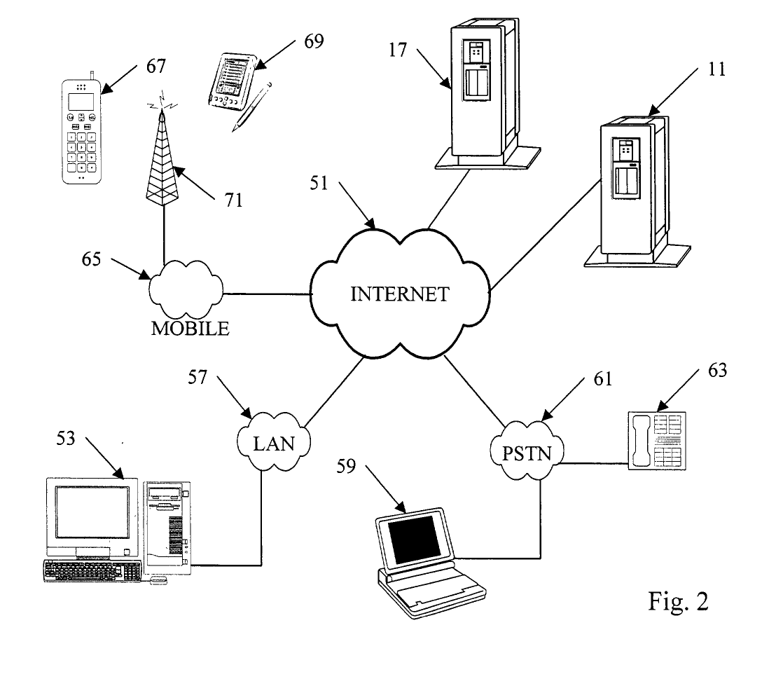

As noted, FIG. 1 illustrates a number of the devices that may utilize the peer-to-peer communications and the logical links between such devices and between the Peer Switch related functionalities. The links extend through a data communication network or networks. Although adaptable to intranet and private virtual network environments, the embodiments utilize Internet communications. Hence, on a physical layer, the logical communications shown in FIG. 1 extend through the public wide area packet switched data network known as the Internet, and in some cases, through various additional networks that connect to the public Internet. To fully appreciate the logical communications, it may be helpful to consider the physical networking involved. FIG. 2 is a simplified diagram illustrating several different types of devices that may be involved in the communications outlined above relative to FIG. 1 and networks that may transport such communications. It is assumed that those skilled in the relevant arts are familiar with the devices, the networks and the means of communications, therefore only a brief summary discussion is provided here.

The Internet 51 generally consists of linked Autonomous System type packet data networks. The Autonomous System are owned and operated by Internet Service Providers (ISPs). Information providers and other on-line service providers operate servers, many of which now connect to the Internet 51 via high speed lines, such as T1/T3 and the like. In the example of the Peer Switch embodiment 10 of FIG. 1, the peer-to-peer communications utilize two servers 11 and 17; and FIG. 2 shows those servers connected for communication via the Internet 51.

End users may operate a variety of different types of devices, which have data communications capabilities; and FIG. 2 shows just a few examples. As shown, a user may have a desk top type personal computer (PC) 53, which will function as one of the Peer Switch clients or as a PC with just a browser, as discussed above relative to FIG. 1. The user's desktop PC 53 may connect through the Internet 51 via a local area network (LAN). 57 or any other convenient wired or wireless access network.

The drawing also shows a laptop PC 59. The laptop PC 59 is generally similar to the desktop unit 53, but the laptop 59 is designed for portability. Typical laptops connect to a local area network in the office (or home), but when the user travels, such a device 59 will often utilize a built-in modem to initiate dial-up access to an ISP modem pool on the Internet 51, via the public switched telephone network (PSTN) 61 or via a wireless data network. PSTN 61 normally provides voice telephone service to and from stations represented by exemplary telephone 63. However, the telephone-based modem capability built into PCs such as 59 (or 53) allow a user to access the Internet 51 from virtually any location having telephone service.

Modern wireless communications networks, represented by the mobile network 65 in the drawing, also provide data communications services to and from a variety of mobile devices. Such mobile user devices may include PCs with appropriate wireless modems. For purposes of discussion here, the mobile network 65 provides mobile wireless communications to a web enabled mobile telephone or “handset” 67 and to a personal digital assistant (PDA) 69.

The construction of a mobile wireless communication network 65, today, typically includes a number of base stations 71 dispersed throughout the service region. The geographic service region may be thought of as made up of a number of individual radio coverage areas, which typically are called “cells.” Within each cell, a base station 71 provides two-way radio communications through its RF front end, essentially for its assigned coverage cell. The users' mobile stations 67, 69 communicate over-the-air, via a standard air-link interface protocol, with one or more of the base stations 71.

Groups of base stations 71 connect to base station controllers, and each base station controller connects to a mobile switching center. In some networks 65, the base stations connect directly to the mobile switching center. In either case, the mobile switching center in turn provides switching between the base stations 71, for example for communications between mobile subscriber stations, as well as switching of communications to and from the public switched telephone network and other mobile switching centers. Modern versions of such networks 65 also include one or more nodes of the network that provide a packet switched coupling to the Internet 51.

For functions involving access or remote control from a wireless device, such as the mobile telephone 67 or the PDA 69, the Peer Switch architecture utilizes spare PC processing power and PC bandwidth to overcome slow wireless network connections that plague traditional wireless data applications. Using Peer Switch, for example, the web-enabled mobile telephone 67 becomes an extended PC keyboard, for example, for remote control of a desktop PC 53 in the user's home or office. Feedback to the phone 67 is provided by carefully formatted text messages instead of screen graphics.

For example, in the Peer Switch embodiment, the web-enabled mobile telephone 67 could locate and forward a 2 MB file on a person's computer 53 in a few seconds using a wireless connection through the network 65. Following this, the remote worker can add and update calendar items in Microsoft Outlook. These schedule changes may be made directly on the user's PC 53 and are instantly available to authorized co-workers and business partners who are members of the community/team of the user.

The end user devices 21, 23, 25, 27 and 29 (FIG. 1) may be implemented in the different physical devices 53, 59, 67 and 69, shown in the network diagram of FIG. 2. The various end user devices and the servers shown in the drawings are fairly well known general purpose computers and/or mobile computing devices. It is assumed that those of skill in the relevant arts will be familiar with the structure, programming and operations of such devices. However, to insure adequacy of the teaching here to various readers, it may be helpful to briefly review the relevant technologies.

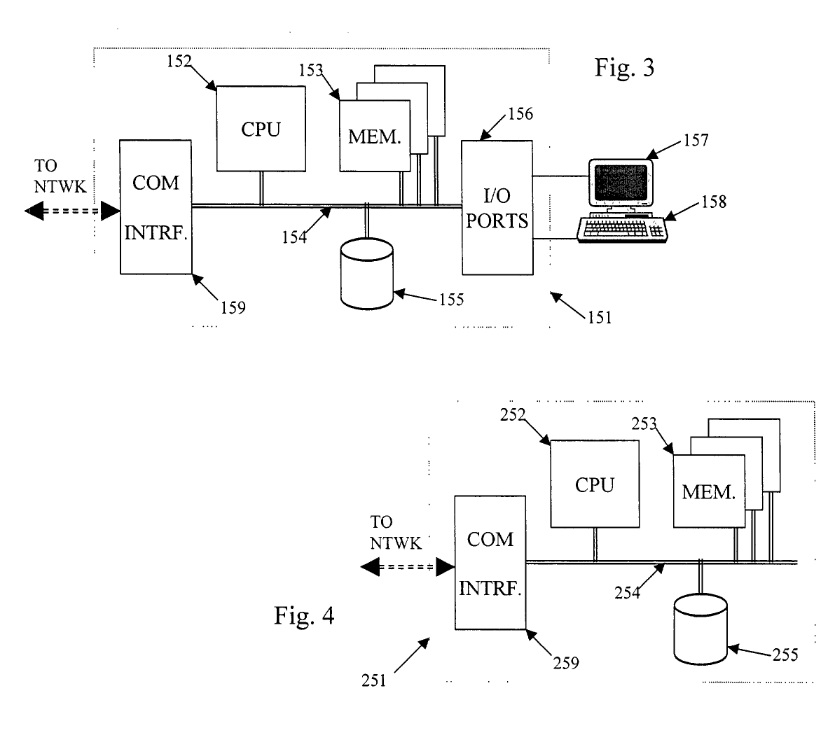

FIG. 3 is a functional block diagram of a PC or workstation type implementation of a system 151, which may serve as one of the user terminals, such as computer 53 or 59 in FIG. 2 (or the various PCs in FIG. 1) for accessing the Peer Switch services and conducting peer-to-peer communications.

The exemplary computer system 151 contains a central processing unit (CPU) 152, memories 153 and an interconnect bus 154. The CPU 152 may contain a single microprocessor, or may contain a plurality of microprocessors for configuring the computer system 152 as a multi-processor system. The memories 153 include a main memory, a read only memory, and mass storage devices such as various disk drives, tape drives, etc. The main memory typically includes dynamic random access memory (DRAM) and high-speed cache memory. In operation, the main memory stores at least portions of data and of instructions for execution by the CPU 152.

The mass storage may include one or more magnetic disk or tape drives or optical disk drives, for storing data and instructions for use by CPU 152. For a home PC, for example, at least one mass storage system 155 in the form of a disk drive or tape drive, stores the operating system and application software as well as data, including received messages and documents. The mass storage 155 within the computer system 151 may also include one or more drives for various portable media, such as a floppy disk, a compact disk read only memory (CD-ROM), or an integrated circuit non-volatile memory adapter (i.e. PCMCIA adapter), to input and output data and code to and from the computer system 151.

The system 151 also includes one or more input/output interfaces for communications, shown by way of example as an interface 159 for data communications via the network 23. The interface 159 may be a modem for data communication via the PSTN 61 or via the mobile network 65, an Ethernet card or the like for communication via the LAN 57, or any other appropriate data communications device. The physical communication links may be optical, wired, or wireless (e.g., via satellite or cellular network).

The computer system 151 may further include appropriate input/output ports 156 for interconnection with a display 157 and a keyboard 158 serving as the respective user interface. For example, the computer may include a graphics subsystem to drive the output display 157. The output display 157 may include a cathode ray tube (CRT) display or liquid crystal display (LCD). Although not shown, the PC type system typically would include a port for connection to a printer. The input control devices for such an implementation of the system 151 would include the keyboard 158 for inputting alphanumeric and other key information. The input control devices for the system may further include a cursor control device (not shown), such as a touchpad, a mouse, a trackball, stylus, or cursor direction keys. The links of the peripherals 157, 158 to the system 151 may be wired connections or use wireless communications.

Each computer system 151 runs an operating system as well as a variety of applications programs and stores data, enabling one or more interactions via the user interface, provided through elements such as 157 and 158, and/or over the network 51 to implement the desired processing for the peer-to-peer communication services. The end-use computer 151, for example, runs a general purpose browser application, and/or a PIM program or an e-mail program. In many cases, the computer 151 will also run one or more instances of the Peer Switch client program and corresponding interface program(s), for the inventive peer-to-peer communications. Some PCs, however, will run a browser but not necessarily a peer client program.

FIG. 4 is a functional block diagram of a general purpose computer system 251, which may perform the functions of the server 11 or the server 17 (or other host computer), or the like. The exemplary computer system 251 contains a central processing unit (CPU) 252, memories 253 and an interconnect bus 254. The CPU 252 may contain a single microprocessor, or may contain a plurality of microprocessors for configuring the computer system 252 as a multi-processor system. The memories 253 include a main memory, a read only memory, and mass storage devices such as various disk drives, tape drives, etc. The main memory typically includes dynamic random access memory (DRAM) and high-speed cache memory. In operation, the main memory stores at least portions of data and of instructions for execution by the CPU 252.

The mass storage may include one or more magnetic disk or tape drives or optical disk drives, for storing data and instructions for use by CPU 252. At least one mass storage system 255, preferably in the form of a disk drive or tape drive, stores the data and programming related to the Peer Switch functions. If the system 251 operates as the first server (Server 1) 13, the mass storage system 255 stores the Peer Switch server application 111 as well as the database 19. If the system 251 operates as the second server (Server 2) 17, the mass storage system 255 stores the Peer Switch web server application 15, as well as the instance(s) 43 of the Peer Switch client and the Peer Switch web interface routine 41. The mass storage 255 may also include one or more drives for various portable media, such as a floppy disk, a compact disk read only memory (CD-ROM), or an integrated circuit non-volatile memory adapter (i.e. PCMCIA adapter) to input and output data and code to and from the computer system 251.

The system 251 also includes one or more input/output interfaces for communications, shown by way of example as an interface 259 for data communications via the network 51. The interface 259 may be a modem, an Ethernet card or any other appropriate data communications device. To perform as one or both of the servers 13, 17 for the peer-to-peer service to a large number of end use customers, the interface 259 preferably provides a relatively high-speed link to the Internet 51.

Although not shown, the system 251 may further include appropriate input/output ports for interconnection with a local display and a keyboard or the like serving as a local user interface for programming purposes. Alternatively, the server operations personnel may interact with the system 251 for control and programming of the system from remote terminal devices via the Internet 51 or some other network link.

The computer system 251 runs a variety of applications programs and stores relevant data, such as the above noted programs for the Peer Switch type peer-to-peer related communications services. Those skilled in the art will recognize that the computer system 251 may run other programs and/or host other Internet service applications, typically web-based or e-mail based services. Also, each system 251 may be implemented as a single computer system or as a distributed system having multiple appearances at different nodes on the Internet 51.

The components contained in the computer systems 151 and 251 are those typically found in general purpose computer systems used as servers, workstations, personal computers, network terminals, and the like. In fact, these components are intended to represent a broad category of such computer components that are well known in the art.

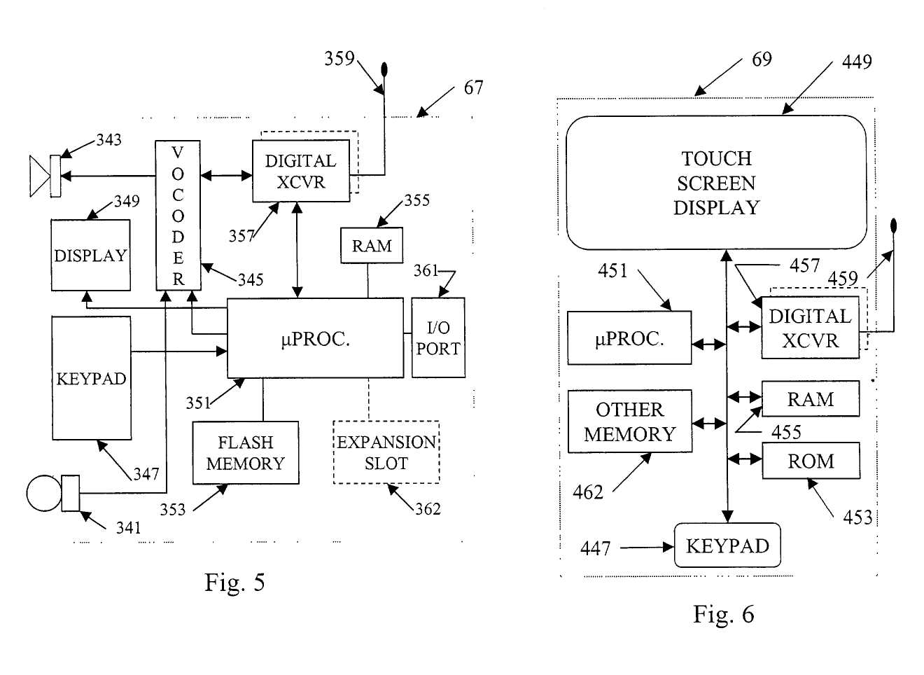

FIG. 5 is a functional block diagram of a simple mobile communication device 67 for use in the network of FIGS. 1 and 2. Although the station 67 may be incorporated into a vehicle mounted mobile unit or into another device, such as a portable personal computer, for discussion purposes the illustration in FIG. 2 shows the station in the form of a handset 67.

The mobile handset 67 functions as a normal digital wireless telephone station. For that function, the station 67 includes a microphone 341 for audio signal input and a speaker 343 for audio signal output (see FIG. 5). The microphone 341 and speaker 343 connect to voice coding and decoding circuitry (vocoder) 345. For a voice telephone call, for example, the vocoder 345 provides two-way conversion between analog audio signals representing speech or other audio and digital samples at a compressed bit rate compatible with the digital protocol of the wireless telephone network communications.

For digital wireless communications, the handset 67 also includes a digital transceiver (XCVR) 357. The present concepts encompass embodiments utilizing any digital wireless transceivers that conform to current or future developed digital wireless communication standards. For example, the transceiver 357 could be a CDMA (IS-95), TDMA or GSM unit, designed for cellular or PCS operation via the network 65 shown in FIG. 2. In the near future, the digital transceiver 357 may be a CDMA transceiver that complies with the 1xRTT standard or other future generation standard. The transceiver 357 provides two-way wireless communication of information, such as vocoded speech samples and digital message information. The transceiver 357 connects through RF send and receive amplifiers (not separately shown) to an antenna 359. The wireless mobile station 67 may include one or more additional transceivers, as shown in dotted line form, for operation in an analog mode or in accord with an alternative digital standard.

As shown, the mobile telephone handset 67 includes a display 349 for displaying messages, a menu generated by a client browser program, call related information, dialed and calling party numbers, etc. A keypad 347 enables dialing digits for voice and/or data calls and generating selection inputs keyed by the user based on the displayed menu.

A microprocessor 351 controls all operations of the handset 67. The microprocessor 351 is a programmable device. The mobile handset unit 67 also includes a flash memory 353 alone or in combination with a read only memory (ROM) and/or a non-volatile random access memory (RAM) 355, for storing various software routines and mobile configuration settings, such as mobile identification number (MIN), etc. In a present implementation, the random access memory RAM 355 stores an operating system, vocoder software, client browser software, device driver software, and call processing software, and may store other application software, for example short message service software, e-mail software etc. For purposes of the inventive peer-to-peer communications, the software may include a Peer Switch client, adapted for the handset, similar to the Peer Switch client (PDA) application 37, although it is envisioned that such devices can rely on the browser and the web server 17. The memories also store data, such as telephone numbers and other data input by the user via the keypad 347. The mobile handset 67 may also include an optional expansion slot 362, to add memory elements or to add other user selected functional elements.

Of particular note, the application software and the transceiver 357 enable a user to operate the mobile unit 67 to conduct two way data communications, via the mobile network 65 and the Internet 51. For purposes of discussions here, these data communications capabilities enable communications with server(s) 17 and/or 11 as well as peer-to-peer communications with devices operated by others in the appropriate user group(s). If the mobile unit relies on the browser, rather than on internal peer client applications, the peer-to-peer communications go through the web server 17.

FIG. 6 shows a handheld computing device 69, for example, in the form of a personal digital assistant (PDA). The handheld computing device may be implemented as a personal organizer, a palmtop computer, a computerized notepad, or the like. As such, the handheld computing device 69 may be any small programmable computing device.

Typically, in a PDA implementation or the like, the device 69 has a microprocessor 451 or the like that is capable of running one or more application programs. The device 69 also has a display, and an input mechanism such as a keypad, a touch-sensitive screen, a track ball, a touch-sensitive pad, a miniaturized QWERTY keyboard, or the like. In the illustrated PDA embodiment, handheld computing device 69 has a touch sensitive display screen 449 and a limited number of input keys in the form of a keypad 447 or the like. The user operates the keys and uses a finger or stylus (or similar implement) on the touch screen display 449 to input information to the device 69. The user observes information shown on the display screen of element 449.

The PDA device 69 can also be implemented with a digital wireless RF (radio frequency) transceiver 69 and/or one or more alternative wireless transceivers such as an IR (infrared) transceiver. If operating via a public mobile network, such as the network 65, the transceiver 457 could be similar to the transceiver 357 in the mobile handset 67. However, the device 69 may be designed to operate in a more localized environment, such as a wireless LAN. For example, short-range wireless communication and personal area networks may be implemented on campuses, in commercial buildings, apartment buildings/complexes or even in individual homes. Currently, Bluetooth technology allows for the replacement of the many LAN cables or the like with short-range radio links and can be used to connect a laptop to a cellular telephone or between other devices such as printers, PDAs, desktops, fax machines, keyboards, joysticks or virtually any other digital device and a desired connection to the Internet 51. Bluetooth radio technology further provides a universal bridge to existing data networks, a peripheral interface, and a mechanism to form small private ad hoc groupings of connected devices away from fixed network infrastructures. Designed to operate in a noisy radio frequency environment, the Bluetooth radio uses frequency hopping scheme to make the link robust. Bluetooth radio modules avoid interference from other signals by hopping to a new frequency after transmitting or receiving a data packet. For operation in such an environment, the transceiver 457 might be a Bluetooth device.

The memory of the device 69 generally includes both volatile memory (e.g., RAM 455) and non-volatile memory (e.g., ROM 453 PCMCIA cards, etc.). The device 69 may include other types of memory 462, such as flash memory, although handheld portable devices today do not typically include disk or tape drives.

An operating system is resident in the memory and executes on the processor 451. The operating system provides a graphical user interface that presents applications and documents and receives user inputs via the touch sensitive display screen 449. The operating system enables execution of applications resident in the memory, both for local functions and for communications using the transceiver 457. The applications may include a browser 39 or preferably a PDA version of the Peer Switch client 37 (see FIG. 1), to enable the inventive peer-to-peer communications.

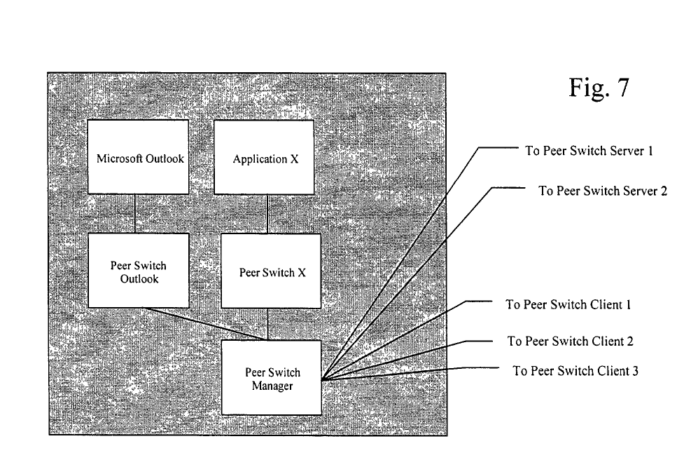

FIG. 7 shows the implementation of an exemplary Peer Switch client. The Peer Switch client carries out the majority of functions provided by the system. The diagram (FIG. 7) shows the high-level software architecture of the client. The Peer Switch client consists of two principal components, the client Manager and the user interface (UI). The Peer Switch client Manager carries out most of the client functions, including accessing local information on the PC for sharing, and handling all network connections. These functions are described in more detail below. There is one Manager for each user device.

The embodiment of FIG. 7 represents an implementation for a PC or the like, which runs other application programs. Here, the Peer Switch UI component runs within the PIM and acts as a front-end to the Manager. The Peer Switch client is designed so that the UI components could be written for any number of PIMs or other applications, e.g. Lotus Notes or Eudora. There can be more than one instance and/or type of Peer Switch UI component running on a PC and communicating with the one Manager at a given time.

At the core of the Peer Switch client is the Peer Switch Manager. It is typically started when an associated PIM or application is started. For purposes of this discussion, it is assumed that the user's device runs Microsoft Outlook as the PIM. When the Peer Switch Manager is started, it first attempts to login to all registered Peer Switches 11. Once logged in, the connections between the Manager and the servers 13 are persistent. Each Peer Switch 11 downloads the list of shares and other users that are available to the user from that community. As other users login and out of the Peer Switch, and as shares are created and deleted on the server 13, it notifies the Peer Switch client over this same connection.

When the user wants to initiate a connection with another peer, either by accessing information on the peer, starting an instant message (IM) session with the peer, or another Peer Switch function, the Peer Switch client sends a message to the Peer Switch that is relayed to the targeted peer, requesting a connection. In current embodiments, the request contains address and port data necessary to make the connection. The remote peer then initiates a network connection back to the requesting peer. The peer-to-peer connection is also persistent between the peers. All subsequent activity between the peers will occur over the same connection, until one or both peers log off.

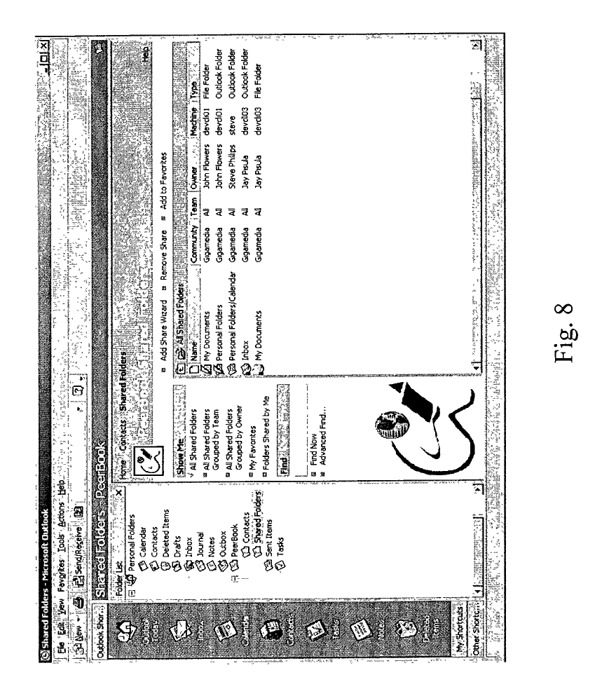

The Peer Switch UI component interacts with the user and displays all information and results through the PIM or application. FIG. 8 is a sample screenshot of Peer Switch Outlook working within Microsoft Outlook.

With such an embodiment of the Peer Switch client, when the user opens Outlook, the Peer Switch service is started and the Peer Switch manager icon may be displayed in the Windows taskbar. Assuming that the user is an established peer member, the user can add the specific computing device to the community and login to the community. The Peer Switch server informs other active members of the community that the user is now online. As shown in drawing (FIG. 8), the peer shares appear as a ‘PeerBook’ folder (with sub folders for contacts and shared folders) in the Outlook folder list.

The peer-to-peer services, particularly in embodiments adapted for implementation with Microsoft Outlook as the user's PIM, offer a PeerOutlook productivity tool, which is designed to provide the ability to securely share Microsoft Outlook information from PC to PC and PC to PDA without storing data on a server. The PeerOutlook tool also provides remote access and management of Outlook information through any web-enabled device such as laptop 59, PDA 69 or mobile phone 67.

Examples of functions that can be performed between Peer Switch clients include:

Sharing Outlook Folders—All of the types of information kept in Microsoft folders (i.e. the PST file), including email, calendar, task, note, and contact items, can be shared.

Sharing Local PC Files—Any file or folder on the local PC can be shared.

IM—Instant messenger sessions can be initiated between users.

Notes—Users can send notes to each other. Notes sent to a user are stored on the Peer Switch server 13 and can be viewed everywhere the user logs onto the system. Notes are deleted explicitly by the recipient user.

PeerMail—Users can send mail directly to one another, bypassing traditional mail servers. Among the benefits of PeerMail are instant delivery and no restriction on the size of email messages or attachments.

Remote Control—The system allows a user to perform control functions on his desktop remotely from another Peer Switch client or the Web. The desktop is replicated on the remote device, and keyboard and mouse input events are sent back to the desktop.

Additional Services—The peer-to-peer connection established between Peer Switch clients preferably is used to support several additional services, including voice over IP (VoIP), conferencing, multimedia streaming and Internet chat.

Notification—The Peer Switch client, acting as an agent for the user on his PC, is used to support several notification services for events like emails received, appointments, instant message requests, etc. Notifications can be sent to pagers, mobile phones, unified or “follow me” messaging systems, other PCs or PDAs, or through the Web.

PeerOutlook is a component of the Peer Switch suite of software productivity tools that provides secure peer-to-peer sharing and collaboration. The secure exchange of data between two peers has been addressed within the PeerOutlook architecture. Outlook information transferred between two peers is strongly encrypted and digitally signed to ensure that the data is not read or modified by other people. PeerOutlook does not require a Microsoft Exchange Server in order for a user to remotely view e-mails or other Outlook information. Data is transferred directly from peer-to-peer without storing data on a server.

The peer user can access information stored in Outlook from anywhere she can browse the Internet. PeerOutlook supports common desktop browsers (Netscape Communicator and Microsoft Internet Explorer); browsers on Palm OS, Windows CE and Blackberry PDAs, and I-Mode and WAP interfaces for cell phones. PeerOutlook features can also be accessed through the Peer Switch Application (stand-alone executable) and Microsoft Outlook using the Peer Switch Outlook add-in type API.

In the embodiment (FIG. 8), the PeerBook Outlook client provides three pages, Home, Contacts and Shared Folders, which are selectable from the folder list or from the tabs at the top of the window. The Home page, for example, lists notes and displays the system activity of the computing device for the current PeerBook session. System activity includes such actions as logging in, logging off, access to shared items, etc.

The Contacts Page lists the members of the community or communities of which the user is a member. The display on the Contacts page preferably provides a color coded listing, where a predetermined color indicates those community members who currently are logged on with the peer service. From the Contacts page, the user can send instant messages and notes to any listed on-line contact. The user can also manage community teams that the user owns or create new teams among community members.

The PeerBook window (shown in FIG. 8) has a main section to the right, which in this example is showing the contents of the selected Shared Folders page. The Shared Folders page lists file and/or e-mail folders to which the user has access. Preferably, color indications identify the shared items that are currently available (due to on-line status of the relevant peer device containing the items). The owner of a folder must be logged on with the peer service at the time, for the folder to be available to the community/team(s) with which it is shared. From the Shared Folders page, the user can access or manage folders or create new shares. Additionally, the user can identify any shared folder as a “Favorite.” The folders displayed on this page may be grouped in different ways, selected by the user, for example, by showing all shared folders, so as to show all shared folders grouped by team, to show all shared folders grouped by owner, to list favorites, or to show the folders shared by the particular user.

Above the main section, the window (FIG. 8) lists various actions that are available to the user, for acting on the current contents of the PeerBook page. The Show Me section of the window provides various options for displaying the page's information. The Find section of the window provides a quick search function, for finding a listing on the particular page. Additionally, on the Shared Folders page, there is an advanced search function that can be used to find specific shared folders or the information that they hold. The upper right section of the window is home to the Help information and any available system options, such as Login and Change Password.

In order to share folder (or drive) information, a team must be defined and the people with whom the user intends to share the information must be identified as members of the team. Once the team is created and a folder is shared with the team, any team member will have access to the folder and its contents whenever the user is logged on to the peer service from the machine containing the share. A team is composed of one or more members who are drawn from a community list. The person who creates the team is automatically made a member of the team and is designated as the Owner. Membership in teams cannot cross communities. All team members belong to the same community. To share information across communities, a user who is a member in each community can set up teams in each community and share the information with both teams. The user device signals all such activities to the Peer Switch 11, which maintains the appropriate records in its database 19.

PeerOutlook allows members of Peer Switch teams to share Outlook folders. Peers can view and manage items stored within Outlook folders, including: E-mail, Contacts, Calendars, Tasks, and Notes. Team members also can restrict management of Outlook information to the owner of the share, all other team members have read-only access.

PeerOutlook allows users to share any Outlook folder at any level with one or more Peer Switch teams. For example, a manager can chose to share his Calendar folder with team “Engineering”. This would enable all members of the engineering team to view the manager's calendar from any PC that has the Peer Switch client installed or any web-enabled device. Once an Outlook folder has been shared, team members will immediately see the newly shared folder within the PeerOutlook client application. If the team member is viewing Peer Switch through a browser, then the folder is shown the next time that the browser is refreshed.

Shared information is peer and member based. Information shared at a particular peer computing device is only available if the member who shared that information is logged in at that computer. However, a community member can be logged in from any number of devices. The folders displayed in the Shared Folders page are all of the folders that the member has shared or that are shared with that member by other team members, via any of the teams of which the user is a member. In a preferred embodiment, a red icon indicates that the member who shred the folder is not currently logged into the peer service at the relevant computing device, therefore, the folder is not currently accessible. In such an embodiment, a green icon indicates that the folder is accessible, that is to say, because the member who shared that folder with the team is logged in at the relevant computing device.

As shown by the above discussion, all information is shared via a defined team. In order to share information, a team must be defined, and the people with whom the user intends to share the information must be identified as members of the team. This is the case even if the user is the only member of the team, where he/she intends to share access to information from his/her multiple devices, e.g. via remote control. For example, the user may log in from a PC and activate the Windows Lock feature or the like, to make it possible to keep the Peer Switch/PeerBook connection active while at the same time preventing unauthorized use of the device. The user can then log in from another device, e.g. a laptop, mobile phone or PDA, and access shared information on the PC. In another example, the user may have shared folders on a desktop PC 53 and on a laptop 59. To be able to access the folders from a PDA 69 or mobile phone 67, the PeerBook user must be logged in with the peer service at server 11, on both the desktop PC and the laptop. When the user logs in via the PDA or mobile phone, shared folders on any one device are available to the other devices, and vice versa.

The “owner” of the shared folder (the ‘share’ in this example) has full read-write access to Outlook information. Other users, however, have read-only access. For example, only owners can forward e-mails using PeerOutlook. This is done because e-mails that a user forwards using PeerOutlook are sent from the default user account within Outlook. PeerOutlook does not allow other people to send e-mails using someone else's e-mail account.

Outlook items, including E-mail, Contacts, Calendars, Tasks, and Notes, can be viewed and managed using PeerOutlook. For example, once a user opens a shared folder that contains e-mails, he will be able to read messages, download attachments, search for e-mails, compose and send messages, reply to a message, forward a message and attach files to a message. To read a message, a user needs only to click on the message he wants to read and it will be displayed on his screen.

When a user opens a shared folder that contains contacts, he will be able to view contact information, search for contacts, add or delete contacts, and edit contact information. When a user opens a shared folder that contains calendar appointments, he is able to view appointments, modify or delete appointments and search appointments. To view an appointment, a user needs only to click on the appointment he wants to see. When a user opens a shared folder that contains tasks, he can view the task list, create new tasks, modify an existing task or delete a task. He can also sort tasks. When a user opens a shared folder that contains notes, he can view the notes, make changes, delete notes and create new notes.

In the embodiments, an instant message (IM) is a communication that the user can send to any member of the community who is currently logged into the peer service. The IM messages travel directly between on-line peer devices via a secure channel through the Internet. In the embodiments, instant messages are managed via the Contacts page of the PeerBook window. In an embodiment of the Peer Switch Outlook client, a green indicator associated with a contact's name on the list denotes a community member who is logged in. Red indicates a community member who is not currently on-line.

To initiate an IM session, the user accesses the Contacts page from the PeerBook window of FIG. 8. The user then selects the desired contact (if on-line) from the list on the Contacts Page. The selected contact's name appears highlighted in the display, and then the user selects “Instant Message” from the menu of options appearing above the contact list. Alternatively, the user may double click on a listed name and select “Instant Message” from the pop-up menu. The Peer Switch client program then generates a PeerBook Messaging window, and the user can type and send a message to the selected member. The contact receives the message and must access the message to complete set-up of the IM session. Once the contact has accepted, the exchange of instant messages between the parties can begin immediately and continue as long as desired. Transfer of messages between the user and the selected contact is as fast as their respective Internet connections will allow. Similar techniques can be used to set-up telephone-like voice over IP sessions and/or video telephone sessions between community members.

The peer service also allows the exchange of notes between members. A note is a communication that can be sent to any member or team of the community regardless of whether or not the intended recipient(s) are on-line. The note remains available for whenever the recipient next logs in to or opens a PeerBook session. Notes can be sent from either the PeerBook Home page or the Contacts page, but notes are read via the PeerBook Home page. A note is stored in the Peer Switch server 13 for the community, until deleted by the recipient.

When the user selects the Notes feature, the Peer Switch client program generates a PeerBook Note window. To send a note, a user selects the “Send Note” option from the menu above the Home page (FIG. 8). From the Contacts page, the user selects the community member or team intended to receive the note and then selects “Send Note” either from the menu above the page or from the pop-up menu if the user double clicked on the recipient's name from the Contacts list. If initiated from the Contact page, the program fills in the “To:” line in the Note window with the recipient data. If initiated from the Home page, the user can fill in the necessary recipient data, for example, from a drop down list activated by clicking on a down arrow associated with the “To:” line in the window display. The user can enter an identifying subject line and then enter the text of the note. After completion of the note, the user selects “Send,” the program closes the note window, and the computing device forwards the note to the server 13, which notifies the intended recipient(s). Each intended recipient receives a notice and can retrieve the note message from the server, either instantly or when the intended recipient next logs in to the community.

Those skilled in the art will recognize that additional functions can be delivered over the peer-to-peer connections of the Peer Switch service using peer client programming similar to that discussed above relative to FIGS. 7 and 8.

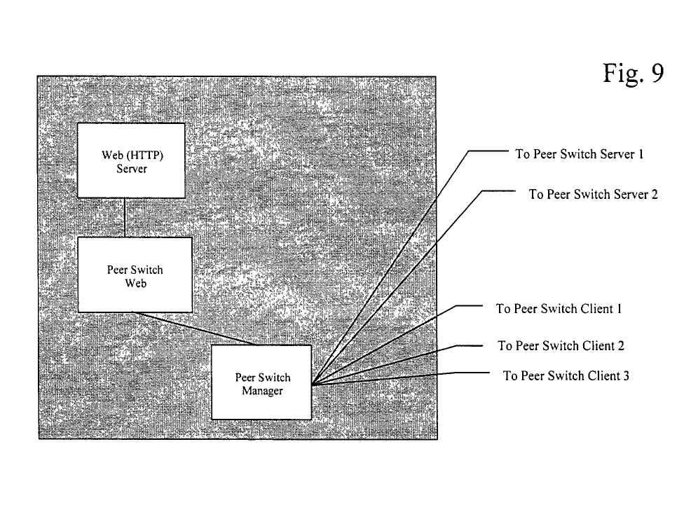

Peer Switch Web is essentially a Peer Switch UI component that acts as a front end to the Peer Switch Manager and presents Peer Switch information through a Web server to remote users. FIG. 9 is a web architecture diagram, similar to the Peer Switch client architecture diagram of FIG. 7. The Peer Switch Web interfaces to and works through the web server program, in a manner analogous to the operation of the Peer Switch client programs through existing PIMs in the embodiment of FIG. 7. The web server program and the Peer Switch Web routine provide a user interface based on web page presentations and user selection of displayed links, via a standard browser application running on the end user's device. Unlike the implementation of FIG. 7, however, the UI of the web embodiment includes communications of a remote device with the web server (shown for example at H in FIG. 1).

When the user logins in through the web server, the Peer Switch Manager first attempts to log the user in to all registered Peer Switches. Once logged in, the connections between the Manager (Peer Switch Web) and the servers are persistent. Each Peer Switch server 11 downloads the list of shares and other users that are available to the user from that community, and the web server 17 provides a page or pages to the user displaying that peer information. As other users login and out of the Peer Switch, and as shares are created and deleted on the Peer Switch server(s), each server 13 notifies the instance of the user's Peer Switch client running on the web server 17, and the client provides updated web pages to the user's browser for display.

Hence, Peer Switch Web (FIG. 9) is a Peer Switch UI component that acts as a proxy for all users logged into a community through the Web server. All of the shares that a user would see on a Peer Switch session on the user's device are shown in the users' Web browser session.

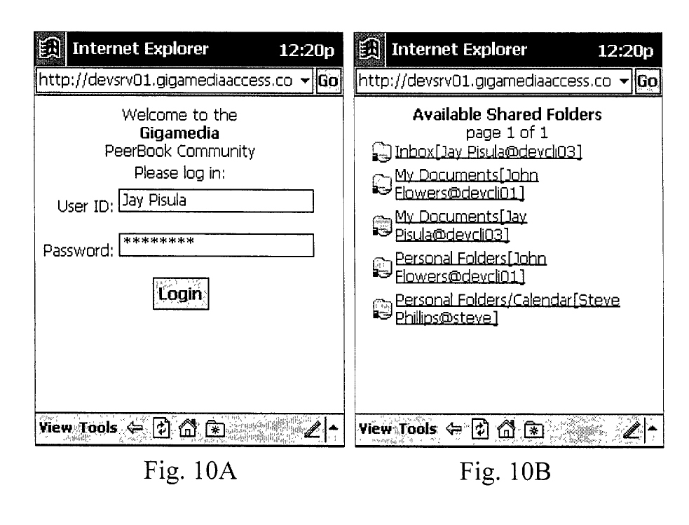

In current implementations, the pages are formatted for two common PDA browsers: Pocket IE for the Pocket PC platform, and Handspring Blazer for the Palm OS platform. The pages will also be formatted for viewing via other common browsers. FIGS. 10A and 10B show examples of two common screens, as they might appear when presented via the Peer Switch Web and the browser on the user's device. These drawings represent screens of Peer Switch Web as they might appear on a Pocket PC. FIG. 10A shows the login screen. FIG. 10B shows the current shares (shared documents/files) available to/from peers within the user's community. In the example of FIGS. 10A and 10B, the user is “Jay Pisula.” The shared folders (FIG. 10B) include folders of several other members of the community (John flowers and Steve Phillips) as well as at least one of the user's own folders (My Documents for JayPisula@devcli03). The displayed pages offer users peer communication features substantially similar to those offered to PC users in the Outlook example discussed above.

In addition to the PDA browser examples discussed above, Peer Switch Web also supports full screen desktop browsers, like Microsoft Internet Explorer and Netscape. Peer Switch Web also supports WML/WAP browsers for web-enabled mobile phone (see 67 in FIG. 2), and the software architecture (FIG. 9) preferably supports other devices capable of browsing the Web.

The Peer Switch embodiment, for enhanced peer-to-peer communications utilizes certain protocols and procedures developed to overcome particular problems and/or provide particular desirable service features. These include protocols and procedures to facilitate the communication between a Peer Switch client and server process and the protocol for client peer-to-peer communications. Consider first the communication between a Peer Switch client and server process.

The protocol used to communicate between a Peer Switch client and the Peer Switch server 11 begins with establishment of a TCP/IP connection between the client device and the server 13 in the normal manner. The client sends transaction requests to the server functionality. In the current format, the Bytes 1-4 of the request include a network long integer, that is to say the number of bytes in this transaction; whereas Bytes 5 through end of transaction contain an XML document of arbitrary length (length given in Bytes 1-4). The server responds to the client with messages in the same format. At times determined by the server, the server sends unsolicited notification transactions to the client in the same format.

The XML documents are in the following formats:

a. Client requests:

<PBReq Action=“Login” UserID=“abc” . . .
/>

b. Server responses:

<PBResp Error=“0”

Action=“Login” UserID=“abc” . . . />
[relevant data elements]

<PBResp/>

c. Server notifications:

<PBNotify>

<PeerPresence PeerID=“1234” . . . />
. . .

<PBNotify/>

The Action attribute on Client Requests identifies the particular transaction requested by a client. The Server Response includes all the attributes of the Client Request, so that the client can later match the response to the request.

The Error attribute on Server Responses indicates the success or failure of a transaction. Success is indicated by a value of “0”. Failure is indicated by any other value, usually a string value denoting the nature of the error.

Server responses may contain any number of child XML elements containing information for the client. These elements may be nested to any level. For example, a response to a PBReq transaction with an action value of “Login” may contain lists of peers online, shared folders available, notes and other data.

PBNotify document elements contain unsolicited information about changes in the state of the Peer Switch community. For example, when another user logs in to or out of the community, a client process is notified of this through a PeerPresence element in a PBNotify transaction. Or, when a folder is shared with a user by another user, the first user client process receives a PBNotify transaction containing an AddShare element.

In the addressing scheme of the Internet, an address comprises four numbers separated by dots. This is called the Internet Protocol address, or IP address. An example of an IP address would be 164.109.211.237. Each machine on the Internet has a unique number assigned to it, which constitutes one of these four numbers. In the IP address, the leftmost number has the greatest weight. By analogy t his would correspond to the ZIP code in a mailing address. At times the first two numbers constitute this portion of the address indicating a network or a locale. That network is connected to the last router in the transport path. In differentiating between two computers in the same destination network only the last number field changes. In such an example the next number field identifies the destination router.

When a packet bearing a destination address leaves the source router, the router examines the first two numbers in a matrix table to determine how many hops is the minimum to get to the destination. It then sends the packet to the next router as determined from that table, and the procedure is repeated. Each router has a database table that finds the information automatically. This continues until the packet arrives at the destination computer. The separate packets that constitute a message may not travel the same path depending on traffic load. However, they all reach the same destination and are assembled in their original order in a connectionless fashion.

Hence, to communicate via the Internet 51, every device must have an IP address. To conduct a session with another device, the IP address of the other device must be known. The IP addresses, however, are a scarce network resource. Hence, many user devices today receive IP addresses only through a dynamic assignment, for the limited period that each such user device is on-line and active. When users go off line, the IP addresses become available for reassignment and reuse by others.

It would be difficult for most people to remember the four separate numbers (sometimes having ten or more digits) comprising each numeric IP address. In addition, as noted the numeric IP addresses of many devices change, making it even more of a problem for people to keep track of them. The Domain Name System (DNS) was developed to provide some relief from these problems. In the DNS system words, which are more easily remembered, are used instead of numbers. The significance of each of the domains is the reverse of that of the numeric IP address. In the numeric IP address, the most significant numbers were on the left and the least significant on the right. The textual Domain Name System begins with the least significant on the left and proceeds to the most significant on the right.

At login with the Peer Switch service, the protocol outlined above will include signaling between the end user's device and the Peer Switch server 11. The user's device knows the address to reach at least one such server based on DNS or direct IP addressing, and the signaling to the server identifies the currently assigned IP address being used by the particular user's device. The notification(s) from the server to the user devices of the community members that are currently on line provides address information necessary to reach those on-line members. The noticed address information could include domain names, which would be translated by the standard DNS services on the Internet, but preferably the notice distribution identifies the current IP addresses for the on-line user devices of the other members.

The protocol used to communicate between two Peer Switch clients also begins with a TCP/IP connection, albeit one now established between the two Peer Switch clients. Either client may send messages to the other in the same format. In this format, Bytes 1-4 (a network long integer) specify the umber of bytes in part A of this transaction. Bytes 5-8 (a network long integer) specify the number of bytes in part B of this transaction. Then Bytes 9 and following contain Part A of the transaction, which either may be an XML document message describing a Peer Request, Response or Instant Message or may be a PeerChannel header. Following Part A, the transaction includes a Part B, which comprises binary data as indicated in Part A.

If Part A is a PeerChannel header, then the first four bytes of Part A are a constant, well-known value called a magic number. Otherwise, Part A is an XML document. The PeerChannels are virtual connections that are “tunneled” through the single TCP/IP connection. Tunnels are established through requests made in XML transactions. The PeerChannel header is comprised of:

a. Bytes 1-4—the magic number indicating that this is a PeerChannel header.

b. Bytes 5-8—various bit flags including the following:

i. 0x00000001—suspend sending data on this channel

ii. 0x00000002—resume sending data on this channel

iii. 0x00000004—close this channel

c. Bytes 9-12—the channel number from which this data originated (the source channel).

d. Bytes 13-16—the channel number for which this data is intended (the destination channel).

Data are delivered through PeerChannels for purposes including file transfers, virtual connections between external programs (e.g., NetMeeting), and streaming video and/or audio data.

XML document messages exchanged between clients represent transaction requests, responses or instant messages:

a. Client requests:

< PBPeerReq Action=“Dirlist” . . .
/>

b. Client responses:

< PBPeerResp Error=“0”

Action=“Dirlist” . . . />
[relevant data elements]

< PBPeerResp/>

c. Instant Messages:

< PBPeerMsg/> [Followed in Part B by the
message itself]

The Action attribute on Client Requests identifies the particular transaction requested by a client. The Response includes all the attributes of the request, so that a client later can match the response to the request.

The Error attribute on Responses indicates the success or failure of a transaction. Success is indicated by a value of “0”. Failure is indicated by any other value, usually a string value denoting the nature of the error.

Responses may contain any number of child XML elements containing information for the client. These elements may be nested to any level. For example, a response to a PBPeerReq with an action value of “DirList” may contain a lists of folders and other items contained in a shared folder.

When the XML document message contains a PBPeerMsg element, then Part B of a message contains an instant message from the user at one client to the user at the other.

The process by which one computer initiates and another computer accepts a TCP/IP connection is well documented and widely used. The process by which two computers simultaneously initiate a TCP/IP connection with each other is documented, but is not implemented in most TCP/IP stacks in use today. For example, such a technique is not implemented in Microsoft's TCP/IP stack, and theirs is the most commonly used stack in the world.

There is no known process by which three computers (A, B and C) already having established TCP/IP connections between A and C and between B and C can then cooperate to establish a TCP/IP connection between A and B. There is no known process by which two computers, each behind a respective firewall, which does not allow any TCP/IP connection to the inside to be initiated from the outside, can establish a TCP/IP connection between themselves. This presents a particular concern for establishing peer-to-peer connections, in an architecture of the type described above relative to FIGS. 1 and 2, where one or more of the peers resides behind a firewall. The Peer Switch embodiment addresses this concern by using a process by which one computer facilitates or brokers the creation of a TCP/IP connection between two other computers, as described in detail below.

FIG. 11 shows three computers, two of which are behind firewalls. In the Peer Switch environment, the computers A and B are end user devices desiring to establish a peer-to-peer session via their client software. These two computers reside behind respective firewalls A and B. The broker computer C is one of the Peer Switch servers (see 11 in FIG. 1 or see FIG. 2). Hence, A, B and C designate three different computers connected in the Internet 51, with computers A and B behind respective firewalls. Typically, the firewalls A and B only allow TCP/IP connections to be initiated from behind the firewall. (In this discussion, A, B and C each also refer to a computer program running on their respective computers.)

Assume that TCP/IP connections already exist between computers C and A and between computers C and B, for example between the Peer Switch server 11 and two peer user devices such as 21 and 27 in FIG. 1. Assume that the users desire to establish a TCP/IP connection between computers A and B, e.g., for peer-to-peer communications. Computer A sends a packet of data to computer (server) C requesting a connection established between port PA on computer A and some port on computer B. The broker computer C (e.g. the server 11) validates that the proposed connection is allowed and sends a request to establish the connection to computer B. This request to B includes the port PA to be used by computer A.

In response to the received request, peer computer B sends an acceptance of the request to broker computer C. This response includes the port number (PB), which peer computer B intends to use for the peer-to-peer connection. Broker computer C (e.g. server 11) now sends an acknowledgment of A's original request to peer computer A. The acknowledgement message includes the port PB to be used by B.

Peer computer device A now initiates a TCP/IP connection from its own port PA to port PB on computer B. However, B's firewall prevents the initial session set-up packet from reaching computer B, since it is a session not initiated from the protected user side of that firewall.

However, in the embodiment A also sends the initial IP packet (PA-P1) for the proposed connection PA-PB to the broker C, through the existing A-C connection. This packet is not normally available to application-level programs, so its capture is of some interest to the discussion here. There are several ways to accomplish this part of the process. One approach is to modify the TCP/IP protocol stack software to make the initial TCP/IP packet available to application programs, e.g. through IOCTL calls (IOCTL refers to input-output control and is used to manipulate a character device via a file descriptor.). Another approach to this capture is to use a packet filtering program to capture such packets and pass them to the program A. Another technique is to create an intermediate NDIS driver or a Hook driver to do the work, on operating systems such as Microsoft Windows. In any of these (or other) cases, the task is to capture the initial packet of a new TCP/IP connection and make it available to the program A, so that the program A can send it to the broker program C through its already-existing connection A-C.

The other peer computer B also initiates a TCP/IP connection, in this case from port PB to port PA on the computer A. Here, A's firewall prevents this packet from reaching computer A, since it is a session not initiated from the protected user side of that firewall. The computer B also sends the initial IP packet (PB-P1) for the proposed connection PB-PA to broker C through the existing B-C connection, in the same manner as described above for the similar packet from program A.

The broker computer C (e.g. server 11) uses information in the initial IP packet PB-P1 to construct an IP packet (PB-P1′), which would have been B's response to IP packet PA-P1, if program B had been listening on port PB and accepted the connection PA-PB (but which was blocked by the firewall B). The broker computer C (e.g. server 11) sends this (raw) IP packet through the network to port PA on computer A as if it had come from the port PB on the computer B. The construction of PB-P1′ packet consists of copying PB-P1 and adding an ACK of the initial sequence number in PA-P1 (plus one).

The broker computer C uses information in initial IP packet PA-P1 to construct an IP packet (PA-P1′) which would have been A's response to IP packet PB-P1, if program A been had listening on port PA and accepted the connection PB-PA PB (but which was blocked by the firewall A). The broker computer C sends this (raw) IP packet through the network to port PB on computer B, as if it had come from the port PA. The construction of PA-P1′ packet consists of copying PA-P1 and adding an ACK of the initial sequence number in PB-P1 (plus one).

To the peer computers, it now appears as if they have received acknowledgements to their respective requests to establish a TCP/IP session. Computers A and B now each respond to the PB-P1′ and PA-P1′ packets with the third packet of the TCP three-way handshake in the normal manner, and the desired TCP/IP connection between A and B is established. In the Peer Switch service, desired peer-to-peer communications now ensue between computer A (via TCP port A) and computer B (via TCP port B).

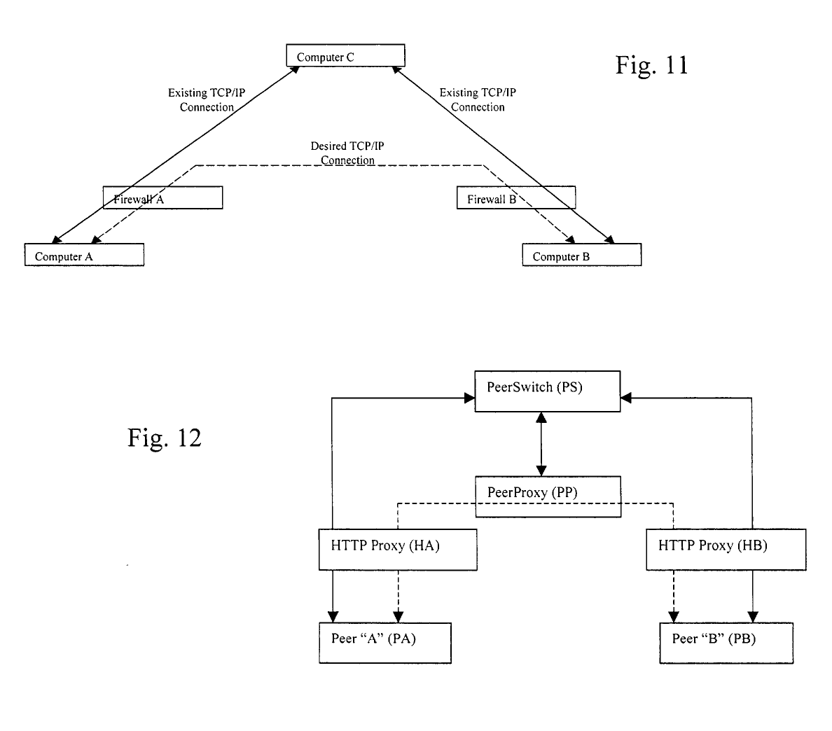

The Peer Switch embodiment also utilizes a particular technique to establish virtual TCP/IP connections between IP-enabled devices (in this case peers), either or both of which may be located behind an HTTP proxy, using a PeerProxy controlled by the Peer Switch. FIG. 12 is a block diagram useful in explaining peer-to-peer communications is accord with this process. As shown, end user computers Peer A (PA) and Peer B (PB) are behind respective HTTP proxies. Each has a proxied connection to a Peer Switch computer (PS), typically a server 11 (FIG. 1 or FIG. 2). The Peer Switch computer (PS) communicates with a PeerProxy (PP), which may reside in one of the servers 11 or 17 (or in a router or other Internet node).

Assume that there are existing connections PA-PS, PB-PS between the peer computers and the Peer Switch server and a connection PP-PS between the PeerProxy and the Peer Switch server. In this example, the user of peer computer PA wants to establish a connection PA-PB with the peer computer PB. A specific example of the method for establishing a virtual TCP/IP connection between two IP-enabled devices (Peers) then proceeds as described below.

First, the originating peer computer PA sends an XML transaction PBReq with Action=Connect, to the Peer Switch server PS. The Peer Switch server PS generates two cryptographically random values of sufficient size as to be practically impossible to predict. The Peer Switch server PS sends these two values to the PeerProxy PP in an XML transaction PBReq Action=Proxy. The PeerProxy PP stores the values in a table of pending connections.

The Peer Switch server PS sends one value to destination peer computer PB, in an XML transaction PBNotify with child node ConnReq containing the value and the IP address of the PeerProxy PP. The Peer Switch server PS sends the other value and the IP address of PeerProxy PP to the originating peer computer PA, in an XML transaction PBResp with Action=Connect and Scheme=PeerConnSchemeProxy.

The originating peer computer PA initiates a normal TCP connection to the associated HTTP proxy server HA at port 80 and sends an HTTP CONNECT request to establish an HTTP tunnel to the PeerProxy server PP at port 443 (or another assigned port). Upon receipt of a success status (200) message, the originating peer computer PA sends the random value it received from Peer Switch server PS.

The destination peer computer PB also initiates a normal TCP connection, in this case to the associated HTTP proxy server HB at port 80 and sends an HTTP CONNECT request to establish an HTTP tunnel to the PeerProxy server PP at port 443 (or another assigned port). Upon receipt of a success status (200) message, the destination peer computer PB sends the random value it received from Peer Switch server PS.

The PeerProxy server PP is listening on port 443 (or another assigned port) for TCP/IP connections. When it accepts one, the PeerProxy server PP expects to receive a random value that matches one in the pending connections table. If it receives such a value within 10 seconds, then it attaches the accepted socket to that portion of the pending connection table. When the PeerProxy server PP accepts a connection and receives a value that matches the second half of the pending connection table entry, the PeerProxy server PP creates an entry in the active connection table, removes the entry from the pending connection table, and begins to forward data received on the one socket to the other socket. In this manner, the PeerProxy provides a logical connection between the connections established with the peer devices A and B, thus enabling the desired peer-to-peer communications. When a socket is closed, the PeerProxy server PP waits until any pending data has been sent to the other socket and then closes the other socket. When both sockets are closed, the entry in the active connection table is removed.

Every thirty seconds, the PeerProxy server PP scans its pending connection table for entries over thirty seconds old, deleting any such entries. Every thirty seconds, the PeerProxy server PP scans its active connection table for entries where one side of the socket has been closed for more than thirty seconds, and performs closing actions on any such entry.

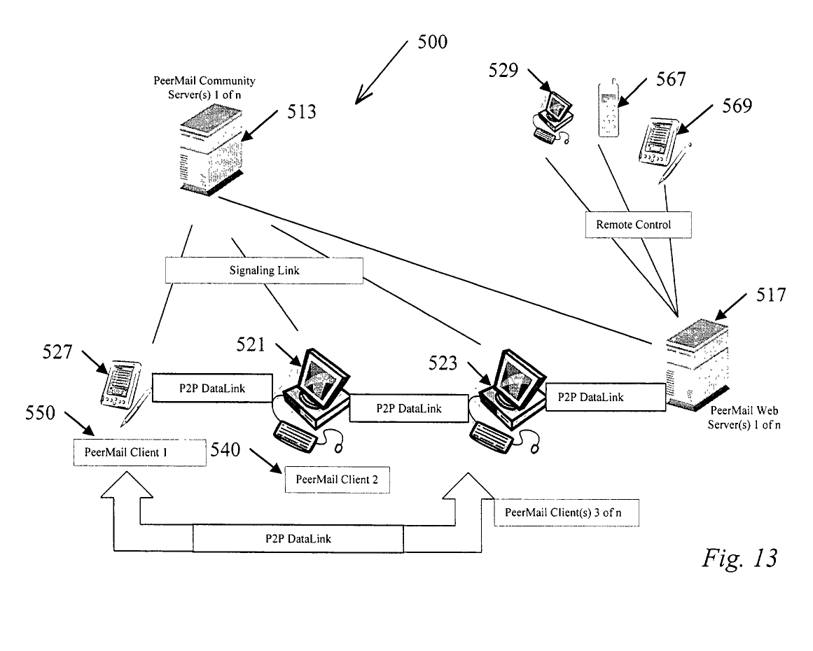

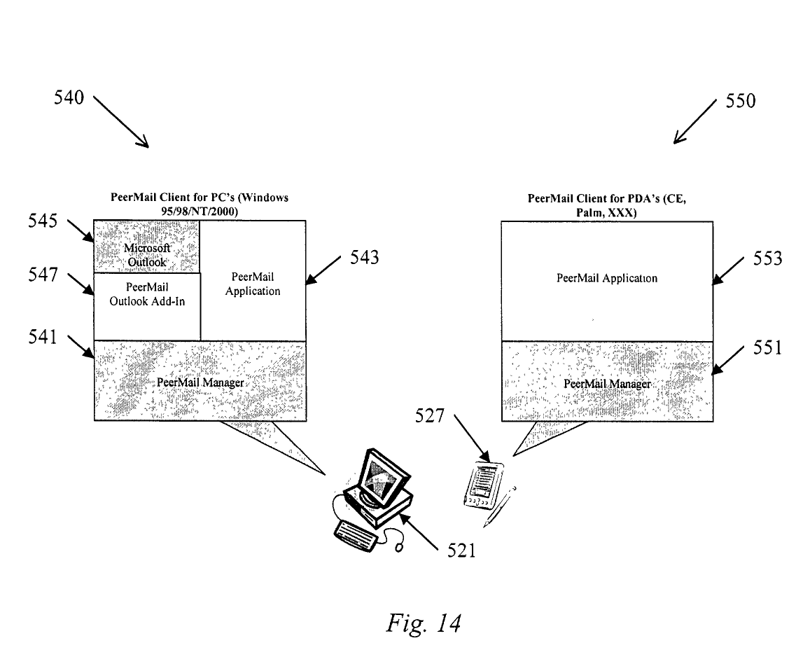

FIGS. 13 and 14 relate to an alternate service embodiment, focused more on peer-to-peer e-mail services, referred to as the PeerMail architecture. The elements of the PeerMail embodiment (FIG. 13) may be similar to those in the Peer Switch embodiment or run in parallel to or even as a subset of the Peer Switch applications on the servers and/or on some of the same end user devices.

PeerMail is a next-generation e-mail application designed for peer-to-peer communications, for example, so as to provide the ability to securely send and receive email messages and attachments from peer-to-peer without passing data through an e-mail server. The embodiment also offers remote control of PeerMail features through any web-enabled device such as laptop, PDA or phone. PeerMail operates across a variety of network obstacles (e.g. firewalls, NAT, and slow wireless connections) that make otherwise make the feature implementation difficult, if not impossible, to accomplish with existing technology.

The PeerMail user interface (UI) is available through Microsoft Outlook, stand-alone applications for Windows PC's, common desktop browsers (Netscape Communicator and Microsoft Internet Explorer), PDA browsers on Palm OS, Pocket PC and Blackberry, and i-mode and WAP interfaces for cell phones. Security is implemented on every network connection made by PeerMail. Digital certificates are used for authentication, strong encryption is used to secure peer-to-peer sessions, and HTTPS is used to secure web sessions. By establishing network connections for e-mail directly between clients (i.e. peer-to-peer connections), PeerMail creates little or no overhead for servers. Mail is sent and received directly from PC to PC or from PC to remote device.

FIG. 13 shows the high-level PeerMail architecture 500. As illustrated, PeerMail consists of three principal components. The system 500 includes two types 513, 517 of servers, end user/client devices 521, 523 and 527 running respective client applications, and remote user devices 529, 567 and 569 accessing a client and application for PeerMail service via a browser and the web, for remote control. The hardware and physical network connections of the illustrated devices are essentially the same as in the Peer Switch embodiment of FIGS. 2-6.

The PeerMail Community server 513 (which may also serve as a Peer Switch Community Server) is responsible for authenticating users into a PeerMail community, and for several administrative activities including presence mapping. Although only one PeerMail Community server 513 appears in the drawing, there may be any number n of such servers, needed to handle the desired level of communications for the number of users. The PeerMail client application 540, 550 resides on the user's PC, PDA or other peer device. The PeerMail client application 540, 550 carries out the majority of PeerMail functions between itself and other peers (Peer-to-Peer data link) or the server 513 (signaling link). The PeerMail Web functionality is responsible for providing remote control access to peers through a web server 517.

The PeerMail server 513 maintains a database of users, teams, and shares within a community. The PeerMail server 513 also authenticates users into the community. As needed, the server 513 generates digital certificates on the fly, for example, when two clients want to connect with each other so they can authenticate one another. The server 513 also notifies a PeerMail client when other users are on-line or off-line, for example, to indicate the status of devices of other members of the user's community or communities. This notification function involves a presence mapping of the users, by the PeerMail server 513. Another function of the PeerMail server 513 is to facilitate connections between peers, for example, when firewalls, proxies and NAT systems exist in the network between the peers, using techniques such as those discussed above relative to FIGS. 11 and 12.

Examples of the PeerMail client architecture, for PCs and PDAs, appear in FIG. 14. In both examples, the PeerMail Client programming 540, 550 includes a PeerMail manager 541, 551 and a PeerMail application program 543, 553. The PeerMail Manager 541 or 551 carries out most of the PeerMail client functions, including sending and receiving e-mail information, and handling all PeerMail network connections. There is one PeerMail Manager routine for each PC or other device programmed as a PeerMail client.

The PeerMail Application program 543 or 553 is a stand-alone executable that contains the front-end user interface to the PeerMail Manager 541 or 551. This application is available for common desktop and PDA operating systems, including Windows 95/98/NT/2000, Palm OS, and CE.

In the PeerMail client 540, the user device runs Microsoft Outlook 547, and the client programming includes a PeerMail Outlook Add-In routine 547. The Add-In routine 547 is a user interface to the PeerMail Manager 541 that has been integrated into Microsoft Outlook 545. The PeerMail client is designed so that the PeerMail UI components could be written for any number of Personal Information Mangers (PIMs) or other applications, e.g. Lotus Notes or Eudora. There can be more than one instance and or type of PeerMail UI component running on a PC and communicating with the PeerMail Manager at one time. For example, in client 540, the application 543 may provide a standalone user interface running in parallel with the user interface provided by Outlook 545 and the Outlook Add-in 547.

The PeerMail Manager 541 or 551 is typically started when the PeerMail application 543, 553 or associated PIM (like Outlook 545) has been started.

When PeerMail Manager is started, it first attempts to login to all registered PeerMail Community servers 513 (FIG. 13). Once logged in, the connections between the PeerMail Manager and the servers 513 are persistent. Each server 513 downloads the list of community members that are available to the user from that community. As other users login and out of PeerMail, the server 513 notifies each PeerMail client of the community over this same connection. All data sent through the “Signal Link” between PeerMail Clients and PeerMail server 513 is strongly encrypted using the TLS protocol (the successor to SSL).

When the user wants to send mail to another peer, the PeerMail client 540 or 550 sends a message to PeerMail server 513 that is relayed to the peer, requesting a connection. The request contains address and port data necessary to make the connection. The remote peer then initiates a network connection back to the requesting peer. PeerMail encrypts data sent between peers and creates a digital signature to ensure that the data cannot be read or changed by anyone who does not have keys to unlock the data. If the peer that a user wants to send mail to is not online, then the message is kept locally on the sender's device until both peers are online at the same time. When the recipient peer comes on-line, the PeerMail server notifies peer devices of all members of that party's community, including the peer device having the stored e-mail message. The sending user may respond to the notice by manually triggering a send routine for the message; or the sending peer' device may automatically execute the Send routine of its client program for the stored message, upon recognition that the intended recipient has come on-line.

Once established for direct mail transfer, the peer-to-peer connection is persistent between peers. All subsequent activity between the peers will occur over the same connection. All data sent between two peers in strongly encrypted.

It may be helpful to consider a few examples of typical PeerMail transactions that occur between Peer Switch server and a PeerMail client and between clients, when sending an e-mail message to another PeerMail client. For purposes of this discussion, assume that peer user at A using device 521 and client programming 540 desires to send a message to peer user at B, who normally utilizes device 527 and client programming 550.

The user on PeerMail client A 540 (Peer A) types an e-mail message on device 521 to be sent to PeerMail client B (Peer B). In this scenario, Peer A and Peer B are not yet connected to each other, but both are online.

When the Peer A user chooses to “send” the message, four hash keys are created that are in turn are used to create encryption keys for use during this peer-to-peer session (i.e. session keys). The client 540 for Peer A causes the device 521 to send a TCP/IP port identifier (chosen at random) and the session keys to PeerMail server 513 and begins listening on the identified TCP/IP port. The PeerMail server 513 passes the session keys and Peer A's TCP/IP port identifier down to the client 550 for Peer B on device 527.

The clients for both Peer A and Peer B now have the same session keys, and the client 550 for Peer B now has Peer A's TCP/IP address and port number to begin communication. The client 550 for Peer B now contacts the client 540 for Peer A using the TCP/IP address and port number, and a peer-to-peer datalink is created directly between the clients on devices 521 and 527.

When Peer A sends data to Peer B, session keys number one and two are used for encryption and decryption. When Peer B sends data to Peer A, session keys number three and four are used for encryption and decryption. In our example, the e-mail message is encrypted using session key one. A digital signature is created using MD5 hashing algorithm and encrypted using session key two and is added to the message data. The device 527 for Peer B receives the data from Peer A, and the client 550 decrypts the e-mail message and digital signature using session keys one and two. The client 550 for Peer B recreates the MD5 digital signature for the e-mail message and compares it to the one sent by Peer A, to ensure that the data has not been changed.

Now if Peer B sends a response e-mail back to Peer A, session keys number three and four are used for encryption and decryption. The return e-mail message is encrypted using session key three. A digital signature is created using MD5 hashing algorithm and encrypted using session key four and is added to the message data. The device 521 for Peer A receives the data from Peer B, and the client 540 decrypts the e-mail message and digital signature using session keys three and four. The client 540 for Peer A recreates the MD5 digital signature for the return e-mail message and compares it to the one sent by Peer B, to ensure that the data has not been changed.

The PeerMail Outlook Add-In 547 allows users to experience PeerMail as another account within Outlook. Using Outlook Contacts, users can tell who is a member of PeerMail and their on-line status (presence mapping). Users can search through PeerMail for contacts to add into Outlook and/or invite Outlook contacts to join the PeerMail community. Users create messages and add attachments using the standard new message user interface provided by Outlook 545. When the user wants to send the message through PeerMail, they select the PeerMail account from the Send drop down button, just as they would do to send from another e-mail account. E-mail is placed in the Sent Items folder after it has been delivered. E-Mail from PeerMail arrives in the Outlook Inbox. Users can open, find, forward, reply, reply all, delete, print, mark as read, mark as unread, and move PeerMail messages. Users can open, print, save as, copy and remove PeerMail attachments.

The PeerMail Application 543 or 553 is a messaging and collaboration front-end to PeerMail Manager 541 or 551. With this Application user interface, contacts can be created, updated, and deleted. A presence map is available to allow users to see current on-line status of other community members. In the current embodiment, the following folders are installed by default with the PeerMail Application: Deleted Items, Drafts, Inbox, Outbox, and Sent Items. Users can create, rename and remove custom folders. The embodiment allows users to perform the following actions for PeerMail Messages: Create, Delete, Find, Forward, Mark as Read, Mark as Unread, Move to Folder, Open, Print, Reply, Reply All and Send. Users also can perform the following actions for E-Mail Attachments: Open, Print, Save As, Copy and Remove.

PeerMail web provides a thin Internet front-end that presents PeerMail information through a web server 517 to remote users, in a manner analogous to the web access in the Peer Switch embodiment. The PeerMail web programming, on server 517, acts as a proxy for all users logged into the PeerMail community through the web server 517. PeerMail messages and attachments that a user would see on a PeerMail session on a PC or the like are shown in the user's web browser session. PeerMail web preferably supports the following browsers: common desktop browsers (Netscape Communicator and Microsoft Internet Explorer); PDA browsers on Palm OS, Pocket PC and Blackberry, and i-mode and WAP interfaces for cell phones. Current PeerMail web embodiments allow users to perform substantially the same functions over the web, which they can perform using the PeerMail Application from one of the client devices, 521, 523, 527.

As should be apparent from the above discussion, certain aspects of invention relate to the software elements, such as the executable code and the database of the Peer Switch or PeerMail server, the software used to implement the web server and associated proxy client functions, the peer client applications, etc. Some or all of these different functions may reside on different physical systems as shown, linked by local or wide area communications networks. Preferably, server components of the inventive software reside in the computer system(s) of the entity who offers the Peer Switch or PeerMail type peer-to-peer services, and the client software resides in the peer devices of members of the teams and communities form the actual user groups. However, the software may reside on other devices and be transferred as needed, to newly program servers or user devices or to upgrade programming of the various peer service systems.

At different times all or portions of the executable code or database for any or all of the software elements may reside in physical media or be carried by electromagnetic media. Physical media include the memory of the computer processing systems (e.g. in FIGS. 3 and 4), or of the portable devices (e.g. in FIGS. 5 and 6), such as various semiconductor memories, tape drives, disk drives and the like of general-purpose computer systems and the mobile computing/communications devices. All or portions of the software may at times be communicated through the Internet 51 or various other telecommunication networks. Such communications, for example, may serve to load the software from another computer (not shown), for example, into one of the servers 11 or 17 (or 513 or 517 in FIG. 13) or into any other peer computer systems or portable user devices utilized in the peer-to-peer communications. Thus, another type of media that may bear the software elements includes optical, electrical and electromagnetic waves, such as used across physical interfaces between local devices, through wired and optical landline networks and over various air-links.

Terms relating to computer or machine “readable medium” as used herein refer to any medium that participates in providing instructions to a processor for execution or for carrying data to or from a processor for storage or manipulation. Such a medium may take many forms, including but not limited to, non-volatile media, volatile media, and transmission media. Non-volatile media include, for example, ROM, optical disks or magnetic disks, such as in any of the storage devices in the systems of FIGS. 3 to 6. Volatile media include dynamic memory, such as main memory (RAM or the like). Transmission media include coaxial cables; copper wire and fiber optics, including the wires that comprise a bus within a computer system. Transmission media can also take the form of electric or electromagnetic signals, or acoustic or light waves such as those generated during radio frequency (RF) and infrared (IR) data communications. Common forms of computer or machine readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, or any other medium from which a computer can read. Various forms of computer or machine readable media may be involved in carrying one or more sequences of one or more instructions or data to a processor for execution.

The drawings and the description above are given by way of example, as a detailed disclosure of presently envisioned embodiments of the peer-to-peer communications. While the foregoing has described what are considered to be the best mode and/or other preferred embodiments, it is understood that various modifications may be made therein and that the invention or inventions disclosed herein may be implemented in various forms and embodiments, and that they may be applied in numerous applications, only some of which have been described herein. It is intended by the following claims to claim any and all modifications and variations that fall within the true scope of the inventive concepts.

Appendix—Acronym List

The written description above uses a number of acronyms to refer to various protocols, message formats, instructions, system components and the like. Although generally known, use of several of these acronyms may not be strictly standardized in the art. For purposes of this discussion, acronyms have been defined as listed below.

| | |
|---|---|
| API | Application Programming Interface |
| ASCII | American Standard Code for Information Interchange |
| CD | Compact Disk |
| CD-ROM | CD - Read Only Memory |
| CPU | Central Processing Unit |
| CRT | Cathode Ray Tube |
| DNS | Domain Name System |
| DRAM | Dynamic Random Access Memory |
| DVD | Digital Video Disk |
| EPROM | Electrically Programmable Read Only Memory |
| HTTP | HyperText Transfer Protocol |
| HTTPS | HyperText Transfer Protocol Secure |
| IM | Instant Message (or Instant Messaging) |
| IOCTL | Input/Output Control |
| IP | Internet Protocol |
| ISP | Internet Service Provider |
| LAN | Local Area Network |
| LCD | Liquid Crystal Display |
| MD5 | Message Digest Algorithm |
| NAT | Network Address Translation |
| NDIS | Network Driver Interface Specification |
| OS | Operating System |
| PC | Personal Computer |
| PCMCIA | Personal Computer Memory Card International Association |
| PCS | Personal Communication Service |
| PIM | Personal Information Manager |
| PROM | Programmable Read Only Memory |
| PSTN | Public Switched Telephone Network |
| RAM | Random Access Memory |
| ROM | Read Only Memory |
| SDK | Software Development Kit |
| SSL | Secure Socket Layer |
| TCP | Transmission Control Protocol |
| TLS | Transport Layer Security |
| UI | User Interface |
| URL | Universal Resource Locator |
| WAP | Wireless Application Protocol |
| XML | eXtensible Markup Language |

What is claimed is:

1. A system for providing peer-to-peer communication services via a data network, comprising:
a plurality of peer devices, each peer device having a user interface and a network interface for enabling communications over the data network;
a peer server, coupled for data communication via the data network, for providing session establishment services for the peer devices;
at least a respective one of the peer devices having a programmable controller and program storage;
a peer client program in the program storage, execution of the peer client program by the programmable controller causing the respective one of the peer devices to conduct signaling communications with the peer server via the data network and to conduct a peer-to-peer communication in a session with an other one of the peer devices via the data network; and
a web server, coupled for data communication via the data network, for providing a web page interface for a browser implemented by one of the peer devices lacking a peer client program and for providing a proxy peer client program for use by the peer device lacking a peer client program, to enable signaling communications via the data network with the peer server and a peer-to-peer communication with an other one of the peer devices via the data network.

2. The system as in claim 1, wherein the peer-to-peer communications include one or more communications selected from the group consisting essentially of: file sharing, folder sharing, e-mail message transfer, instant messaging, remote control, voice conversation, and video conferencing.

3. The system as in claim 1, wherein:
the peer server maintains a database of users and information as to which peer devices are on-line at a given time; and
the signaling communications include signaling to the peer devices of on-line status of other peer devices.

4. The system of claim 3, wherein:
the peer server identifies a plurality of the users as members of a community; and
signaling of on-line status to a peer device of, one of the members relates to the on-line status of peer devices of members of the community.

5. The system of claim 4, wherein:
the peer server further identifies a subset of members of the community as members of a team; and
the signaling of on-line status to a peer device of one of the members of the team relates to the on-line status of peer devices of members of the team and availability of shared materials stored on peer devices of members of the team.

6. The system as in claim 1, wherein the peer client program is configured for execution in a type of peer device selected from the group consisting essentially of: a personal computer, a personal digital assistant and a wireless mobile telephone device.

7. The system as in claim 1, wherein the session establishment services provided by the peer server include providing digital certificates to peer devices, to facilitate mutual authentication during peer-to-peer communications.

8. The system as in claim 1, wherein the peer client program comprises a peer service manager routine and an application program interface for interaction with another program having a user interface functionality.

9. The system as in claim 8, wherein the application program interface is configured for interaction with a personal information manager program.

10. The system as in claim 9, wherein the application program interface is configured for interaction with Microsoft Outlook.

11. The system as in claim 1, wherein the web server comprises:
a web-based user interface program supporting browser interaction via the data network;
an implementation of a peer client program having an application programming interface to the web-based user interface program; and
a peer service manager routine coupled to the web implementation of the peer client program.

12. The system as in claim 11, wherein the web-based user interface program supports access from one or more types of browsers selected from the group consisting of: a personal computer browser, a personal digital assistant browser and a wireless application protocol browser.

13. A system for providing peer-to-peer communication services via a data network, comprising:
a plurality of peer devices, each peer device having a user interface and a network interface for enabling communications over the data network;
a peer server, coupled for data communication via the data network, for providing session establishment services the peer devices, of users grouped together as members in a plurality of communities;
at least a respective one of the peer devices of a member in an identified community having a programmable controller and program storage; and
a peer client program in the program storage, execution of the peer client program by the programmable controller causing the respective one of the peer devices to conduct signaling communications via the data network with the peer server to establish a communication session with a peer device of a member in the identified community, and to conduct a peer-to-peer communication with the peer device of the peer member in the identified community via the data network.

14. The system as in claim 13, wherein the peer server maintains a database of records identifying members in respective ones of the communities and on-line status of peer devices of the members in the respective communities.

15. The system as in claim 15, wherein the session establishment services provided by the peer server include presence mapping regarding peer devices of members of the respective ones of the communities.

16. The system as in claim 13, wherein the session establishment services provided by the peer server include providing digital certificates to two peer devices for use in a peer-to-peer communications session.

17. A program product, comprising executable code transportable by at least one machine readable medium, wherein execution of the code by a programmable user device causes the programmable user device to perform signaling communications via a data network with a peer server and peer-to-peer communications via the data network with another user device, the executable code comprising:
a peer service manager routine for managing accessing of local information on the programmable user device for sharing via the peer-to-peer communications, and for handling network connections for the signaling communications and for the peer-to-peer communications; and;
a peer service user interface program acting as a front-end for the peer service manager routine and controlling input and output of information via one or more user interface components of the programmable user device.

18. The program product of claim 17, wherein the peer service user interface program implements an application program interface for interaction with another program having a common user interface functionality for the programmable user device.

19. The program product as in claim 18, wherein the application program interface is configured for interaction with a personal information manager program.

20. The system as in claim 19, wherein the application program interface is configured for interaction with Microsoft Outlook.

21. A program product, comprising executable code transportable by at least one machine readable medium, wherein execution of the code by a programmable user device causes the programmable user device to perform signaling communications via a data network with a peer server and peer-to-peer communications via the data network with another user device, the executable code comprising:
a peer service manager routine for managing accessing of local information on the programmable user device for peer-to-peer communications, and for handling network connections for the signaling communications and the peer-to-peer communications; and;
a peer mail service user interface program acting as a front-end for the peer service manager routine and controlling user input and output operations to enable peer-to-peer e-mail exchange via the peer service manager routine and the peer-to-peer communications.

22. The program product of claim 21, wherein the peer service user interface program implements an application program interface for interaction with another program having a common user interface functionality for the programmable user device.

23. The program product as in claim 22, wherein the application program interface is configured for interaction with a personal information manager program.

24. The system as in claim 23, wherein the application program interface is configured for interaction with Microsoft Outlook.

25. A peer server, comprising:
a programmable server computer comprising data and program storage, a central processing unit for execution of programming from the storage, and an interface for communication via a data communication network;
a peer service application resident in the storage; and
a database of peer information maintained in the storage, wherein:
the database identifies peer users and shared data items that the peer users make available for sharing with other peer users, and
the peer service application causes the programmable server computer to authenticate users, as peer users log in with the server, and to dynamically maintain information in the database, as the peer users log in and out with the server from respective peer devices and modify information regarding data items available for sharing among the peer users.

26. The peer server as in claim 25, wherein the database associates peer users into communities.

27. The peer server as in claim 26, wherein the database associates a subset of peer users within a community into a team.

28. The peer server as in claim 27, wherein:
the peer service application causes the programmable server computer to dynamically update the database with information as to on-line status of peer user devices associated with users in the team; and
the peer service application causes the programmable server computer to provide notices, through the network to peer user devices associated with users in the team, of on-line status of other peer user devices associated with users in the team.

29. The peer server as in claim 25, wherein the peer service application causes the programmable server computer to generate digital certificates and supply the digital certificates through the network to peer user devices, to enable peer user devices to authenticate one another.

30. The peer server as in claim 25, wherein the peer service application is adapted to causes the programmable server computer to provide services in support of file sharing between peer user devices.

31. The peer server as in claim 25, wherein the peer service application is adapted to causes the programmable server computer to provide services in support of peer-to-peer exchange of e-mail between peer user devices.

32. A peer service web server, comprising:
a programmable server computer comprising program storage, a central processing unit for execution of programming from the storage, and an interface for communication via a data communication network;
a web server program in the program storage, execution of the web server program by the central processing unit causing the programmable server computer to provide browser interaction with user devices via the data network;
a shared proxy peer client application program in the program storage, execution of the peer client application program by the central processing unit causing the programmable server computer to interface through the web server program to provide a peer service user interface via browser interaction with a plurality of the user devices; and
a peer manager routine in the program storage, execution of the peer manager routine by the central processing unit causing the programmable server computer to manage network connections for signaling communications with a peer service server functionality and peer-to-peer communications with remote computing devices for peer user devices accessing the peer service web server via the browser interaction.

33. The peer service web server as in claim 32, wherein the peer client application program and the peer manager routine are adapted to facilitate one or more peer-to-peer communications selected from the group consisting essentially of: peer-to-peer information sharing, peer-to-peer e-mail exchange, peer-to-peer note exchange, peer-to-peer instant messaging, peer-to-peer voice conversation, peer-to-peer video conferencing, peer-to-peer multimedia streaming, and remote control of a peer device.

34. A peer user device comprising:
a programmable computing device comprising program storage, a central processing unit for execution of programming from the storage, an interface for communication via a data communication network, and one or more elements providing an interface for user input and output;
a peer service manager routine in the program storage, for managing accessing of local information on the programmable computing device for peer-to-peer communications through the network, and for handling network connections for the signaling communications with a server and for the peer-to-peer communications; and;
a peer service user interface program in the program storage, acting as a front-end for the peer service manager routine to enable peer-to-peer communications and associated user input and output.

35. The peer user device of claim 34, wherein the peer service manager routine and the peer service user interface program are configured to support one or more peer-to-peer communications selected from the group consisting essentially of: peer-to-peer information sharing, peer-to-peer e-mail exchange, peer-to-peer note exchange, peer-to-peer instant messaging, peer-to-peer voice conversation, peer-to-peer video conferencing, peer-to-peer multimedia streaming, and remote control of a peer device.

36. The peer user device of claim 34, wherein the peer service user interface program implements an application program interface for interaction with another program contained in the storage having a user interface functionality for the programmable computing device.

37. The peer user device of claim 36, wherein the application program interface is configured for interaction with a personal information manager program contained in the storage.

38. The peer user device of claim 37, wherein the application program interface is configured for interaction with Microsoft Outlook.

39. The peer user device of claim 34, wherein the programmable computing device comprises a device of a type selected from the group consisting essentially of: a desktop personal computer, a laptop personal computer, a personal digital assistant and a wireless mobile telephone.

40. The peer user device of claim 34, wherein the peer service manager routine is configured for receiving a digital certificate from signaling from the server and for exchanging digital certificates with another peer user device for authentication during the peer-to-peer communications.

41. A method of establishing a desired connection for a peer-to-peer communication session through a data network between an originating peer device and an intended destination peer device, wherein at least the intended destination peer device is behind a firewall, the method comprising:
establishing communication through the network, from each of the peer devices to a broker device;
communicating a request for a desired connection with the intended destination peer device, from the originating peer device to the broker device through the network, the request for connection including session related data assigned by the originating peer device;
sending a request to establish connection, from the broker device to the intended destination peer device through the network, the request to establish connection containing the session related data assigned by the originating peer device;
responsive to the receipt of the request to establish connection, sending an acceptance from the intended destination peer device to the broker device, the acceptance including session related data assigned by the intended destination peer device;
sending an acknowledgment of the request for the desired connection, to the originating peer device from the broker device, the acknowledgment of the request for the desired connection containing the session related data assigned by the intended destination peer device;
sending an initial session packet of the desired connection with the intended destination peer device through the data network from the originating peer device, so that the broker device receives the initial session packet from the originating peer device;
sending an initial session packet of the desired connection through the data network from the intended destination peer device, so that the broker device receives the initial session packet from the intended destination peer device;
formulating an acknowledgement of the initial session packet from the originating peer device, based on information from the initial session packet received from the intended destination peer device;
transmitting the acknowledgement of the initial session packet from the originating peer device, through the network from the broker device to the originating peer device;
formulating an acknowledgement of the initial session packet from the intended destination peer device, based on information from the initial session packet received from the originating peer device;
transmitting the acknowledgement of the initial session packet from the intended destination peer device, through the network from the broker device to the intended destination peer device;
conducting peer-to-peer communications through the network, between the originating peer device and the intended destination peer device, responsive to the acknowledgements of the initial session packets sent by the broker computer.

42. The method of claim 41, wherein the desired connection comprises a TCP/IP session between the originating peer device and the intended destination peer device.

43. The method of claim 42, wherein:
the session related data assigned by the originating peer device comprises a first identifier identifying a port assigned by the originating peer device; and
the session related data assigned by the intended destination peer device comprises a second identifier identifying a port assigned by the intended destination peer device.

44. A method of establishing a desired connection for a peer-to-peer communication session through a network between an originating peer device and an intended destination peer device, wherein each peer device is behind a proxy server, the method comprising:
sending a request for a connection through the network from the originating peer device to a broker server;
generating two random values;
supplying the random values from the broker server to a peer proxy;
sending a first one of the random values through the network from the broker server to the originating peer device;
sending a second one of the random values through the network from the broker server to the intended destination peer device;
initiating a first connection, across a first proxy server, from the originating peer device to the peer proxy;
sending the first random value via the first connection to the peer proxy;
initiating a second connection, across a second proxy server, from the intended destination peer device to the peer proxy;
sending the second random value via the second connection to the peer proxy;
upon receipt of the first and second random values from the originating peer device and the intended destination peer device, enabling communications between the first and second connections.

45. The method of claim 44, wherein the desired connection comprises a TCP/IP session between the originating peer device and the intended destination peer device.

46. The method of claim 44, wherein messages sent to and from the peer devices during the steps of establishing the desired connection comprise XML transactions.
